(19) United States
(12) Patent Application Publication
(10) Pub. No.: US 2026/0257215 A1
(43) Pub. Date: Sep. 3, 2026

(54) Methods of Regenerating Aromatization Catalysts

(71) Applicant: Chevron Phillips Chemical Company LP, The Woodlands, TX (US)

(72) Inventors: Gabriela D. ALVEZ-MANOLI, Kingwood, TX (US); Joseph J. BERGMEISTER, Kingwood, TX (US); Basseem HALLAC, Kingwood, TX (US); Max P. MCDANIEL, Bartlesville, OK (US); Mark L. HLAVINKA, The Woodlands, TX (US); Katherine BARTA, Kingwood, TX (US); Israel GARCIA, Kingwood, TX (US); Scott G. MORISSON, Kingwood, TX (US); Patrick POURREAU, Pascagoula, MS (US)

(21) Appl. No.: 19/165,474

(22) PCT Filed: Mar. 22, 2024
(86) PCT No.: PCT/US2024/021132

§ 371 Date: Sep. 15, 2025

Related U.S. Application Data
(60) Provisional application No. 63/491,703, filed on Mar. 22, 2023.
(60) Provisional application No. 63/493,418, filed on Mar. 31, 2023.
(60) Provisional application No. 63/568,189, filed on Mar. 21, 2024.

(51) Int. Cl. B01J 38/46; B01J 38/10

(52) U.S. Cl. CPC B01J 38/46; B01J 38/10

(57) ABSTRACT

Methods of regenerating spent catalysts, such as spent aromatization catalysts, which may include a transition metal and a catalyst support. The methods may include contacting a catalyst with a fluorine-containing stream that includes a fluorine-containing compound. The fluorine-containing compound may include a hydrofluorocarbon (HFC), a chlorofluorocarbon (CFC), a hydrochlorofluorocarbon (HCFC), a fluorocarbon (FC), or a combination thereof.

### CROSS-REFERENCE TO RELATED APPLICATIONS

This application claims priority to U.S. Provisional Patent Application No. 63/568,189, filed Mar. 21, 2024, U.S. Provisional Patent Application No. 63/493,418, filed Mar. 31, 2023, and U.S. Provisional Patent Application No. 63/491,703, filed Mar. 22, 2023, which are incorporated by reference herein.

### TECHNICAL FIELD OF THE INVENTION

This disclosure relates to methods of regenerating spent aromatization catalysts, and their use in aromatizing aliphatic hydrocarbons to aromatic hydrocarbons.

### BACKGROUND

Aromatization catalysts can be regenerated with processes that include chlorination, oxidation, and fluorination. The fluorination typically is performed with a fluorination source that includes fluorine gas in nitrogen, which can be disadvantageous, especially with regard to the distribution of fluorine through a catalyst bed. Fluorine may react with a catalyst upon contact, so a leading edge of a catalyst bed may have a higher concentration of fluorine than the rest of the bed. In some instances, most, if not all, of the fluorine can be adsorbed by a catalyst, with little or no fluorine breakthrough in the bed.

There remains a need for improved methods of regenerating aromatization catalysts, including methods that overcome one or more of the foregoing disadvantages regarding the use of fluorine in a fluorination step.

### SUMMARY

This summary is provided to introduce various concepts in a simplified form that are further described below in the detailed description. This summary is not intended to identify required or essential features of the claimed subject matter nor is the summary intended to limit the scope of the claimed subject matter.

Provided herein are methods of regenerating aromatization catalysts that may include using a fluorine-containing compound, instead of fluorine, in a fluorination step. The use of the fluorine-containing compounds herein may improve fluorine distribution across a catalyst bed.

In one aspect, methods of regenerating a catalyst, such as a spent aromatization catalyst, are provided. The spent catalyst may include a transition metal and a catalyst support in a metal reactor. In some embodiments, the methods include any two or more of steps (A)-(H): (A) contacting a hydrocarbon feed with an aromatization catalyst including a transition metal and a catalyst support under reforming conditions in a metal reactor system to produce an aromatic product; (B) performing step (A) for a time period sufficient to form a spent catalyst: (C) contacting the spent catalyst with hydrogen gas to produce a stripped spent catalyst; (D) subjecting the stripped spent catalyst to a carbon burn at a temperature, such as a temperature not exceeding about 500° F., for a time effective to remove from the spent catalyst at least a portion of the hydrogen carbon feed, at least a portion of the aromatic product, or a combination thereof to form a treated spent catalyst; (E) contacting the treated spent catalyst with a chlorine-containing stream that includes a chlorine-containing compound to produce a chlorinated spent catalyst; (F) subjecting the chlorinated spent catalyst to a carbon burn at a temperature, such as a temperature not exceeding 900° F., for a time effective to improve a dispersion of the transition metal in the chlorinated spent catalyst to form a redistributed spent catalyst; (G) contacting the redistributed spent catalyst with a fluorine-containing stream including a fluorine-containing compound to form a regenerated catalyst; and (H) reducing the regenerated catalyst.

In some embodiments, the methods include contacting a spent catalyst with a chlorine-containing stream including a chlorine-containing compound to produce a chlorinated spent catalyst; contacting the chlorinated spent catalyst with a decoking gas stream including oxygen to produce a de-coked catalyst; and contacting the de-coked catalyst with a fluorine-containing stream including a fluorine-containing compound to produce a regenerated catalyst. In some embodiments, the fluorine-containing compound includes a hydrofluorocarbon (HFC), a chlorofluorocarbon (CFC), a hydrochlorofluorocarbon (HCFC), a fluorocarbon (FC), or a combination thereof.

In another aspect, reactivated catalysts and regenerated catalysts are provided, such as those produced by any of the methods described herein.

In a still further aspect, methods of contacting a reactivated catalyst or a regenerated catalyst and a hydrocarbon to produce a product are provided.

In yet another aspect, methods of contacting a spent catalyst with a fluorine-containing stream are provided. In some embodiments, the methods include (a) providing two or more reactors in fluid communication with each other, wherein the two or more reactors are connected in a series, thereby permitting a fluorine-containing stream to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors, wherein each of the two or more reactors includes a reservoir in which a spent catalyst is disposed; (b) heating one of the two or more reactors to a temperature that is equal to or greater than a fluorination temperature, and maintaining each of the remaining reactors of the two or more reactors at a temperature less than the fluorination temperature, wherein the fluorination temperature is effective to at least partially decompose a fluorine-containing compound of the fluorine-containing stream; and (c) injecting the fluorine-containing stream and circulating or recirculating the fluorine-containing stream for a time effective to achieve a desired level of fluorination of the spent catalyst in the one of the two or more reactors at the temperature that is equal to or greater than the fluorination temperature. The methods may also include (d) heating a different one of the two or more reactors to a temperature that is equal to or greater than the fluorination temperature, and maintaining each of the remaining reactors of the two or more reactors at a temperature less than the fluorination temperature; and (e) injecting the fluorine-containing stream and circulating or recirculating the fluorine-containing stream for a time effective to achieve a desired level of fluorination of the spent catalyst in the different one of the two or more reactors at the temperature that is equal to or greater than the fluorination temperature.

In a further aspect, systems for fluorinating a spent catalyst are provided. In some embodiments, the systems include (a) two or more reactors, and (b) two or more heating apparatuses. The two or more reactors may be in fluid communication with each other, and connected in a series. This configuration may permit a fluid stream, such as a fluorine-containing stream, to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors. The two or more heating apparatuses may be configured to heat each of the two or more reactors to the same or different temperatures. For example, the reactors and apparatuses may be coupled so that one reactor is coupled with one heating apparatus.

Additional aspects will be set forth in part in the description which follows, and in part will be obvious from the description, or may be learned by practice of the aspects described herein. The advantages described herein may be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

FIG. 1 depicts an embodiment of a system provided herein, which may be used to perform one or more embodiments of contacting a spent catalyst and a fluorine-containing stream.

FIG. 2 depicts a plot of catalyst adjusted temperature versus time for an embodiment of a catalyst subjected to an embodiment of the methods described herein.

FIG. 3 depicts a plot of aromatics selectivity versus time for an embodiment of a catalyst subjected to an embodiment of the methods described herein.

FIG. 4 depicts a plot of the catalyst adjusted temperature versus time for (1) an embodiment of a fresh aromatization catalyst, (2) an embodiment of a spent aromatization catalyst, and (3) an embodiment of a spent aromatization catalyst subjected to the embodiment of the reactivation procedure described herein at Example 1C.

FIG. 5 depicts a plot of aromatics selectivity versus time for (1) an embodiment of a fresh aromatization catalyst, (2) an embodiment of a spent aromatization catalyst, and (3) an embodiment of a spent aromatization catalyst subjected to the embodiment of the reactivation procedure described herein at Example 1C.

FIG. 6 depicts a plot of the catalyst adjusted temperature versus time for (1) an embodiment of a fresh aromatization catalyst, (2) an embodiment of a spent aromatization catalyst, and (3) a spent aromatization catalyst subjected to the embodiment of the reactivation procedure described herein at Example 1D.

FIG. 7 depicts a plot of aromatics selectivity versus time for (1) an embodiment of a fresh aromatization catalyst, (2) an embodiment of a spent aromatization catalyst, and (3) a spent aromatization catalyst subjected to the embodiment of the reactivation procedure depicted at Example 1D.

### DEFINITIONS

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2^{nd} Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

As the various features of the subject matter of this disclosure are described, within particular aspect, a combination or combinations of the different features may be envisioned. For every aspect of every feature disclosed herein, all combinations that do not detrimentally affect the designs, compositions, systems, processes, or methods described herein are contemplated with or without the express description of that particular combination. Therefore, unless explicitly stated to the contrary, any aspect of feature disclosed here may be combined to describe and disclose the inventive designs, compositions, systems, processes, or methods consistent with the entire disclosure.

While compositions and methods are described in terms of “comprising” various components or steps, the compositions and methods can also “consist essentially of” or “consist of” the various components or steps, unless stated otherwise.

The terms “including”, “with”, and “having”, as used herein, are defined as comprising (i.e., open language), unless specified otherwise.

The terms “a,” “an,” and “the” are intended to include plural alternatives, e.g., at least one. For instance, the disclosure of “a fluorine-containing compound,” “a catalyst,” and the like, is meant to encompass one, or mixtures or combinations of more than one, fluorine-containing compound, catalyst, and the like, unless otherwise specified.

Various numerical ranges are disclosed herein. When Applicants disclose or claim a range of any type, Applicants' intent is to disclose or claim individually each possible number that such a range could reasonably encompass, including end points of the range as well as any sub-ranges and combinations of sub-ranges encompassed therein, unless otherwise specified. For example, by disclosing a weight percentage of from 1.0 wt % to 2.0 wt %, or 1 wt % to 2 wt %, Applicant's intent is to recite individually 1.0 wt %, 1.1 wt %, 1.2 wt %, 1.3 wt %, 1.4 wt %, 1.5 wt %, 1.6 wt %, 1.7 wt %, 1.8 wt %, 1.9 wt %, and 2.0 wt %, including any sub-ranges and combinations of sub-ranges encompassed therein, and these methods of describing such ranges are interchangeable. Moreover, all numerical end points of ranges disclosed herein are approximate, unless excluded by proviso. As a representative example, if Applicants state that one or more steps in the processes disclosed herein can be conducted at a temperature in a range from 10° C. to 75° C., this range should be interpreted as encompassing temperatures in a range from “about” 10° C. to “about” 75° C. unless otherwise stated.

Values or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, each use of the term “about” can, independently, mean ±20% of the stated value, ±15% of the stated value, ±10% of the stated value, ±5% of the stated value, or ±3% of the stated value.

Applicants reserve the right to proviso out or exclude any individual members of any such group of values or ranges, including any sub-ranges or combinations of sub-ranges within the group, that can be claimed according to a range or in any similar manner, if for any reason Applicants choose to claim less than the full measure of the disclosure, for example, to account for a reference that Applicants can be unaware of at the time of the filing of the application. Further, Applicants reserve the right to proviso out or exclude any individual substituents, analogs, compounds, ligands, structures, or groups thereof, or any members of a claimed group, if for any reason Applicants choose to claim less than the full measure of the disclosure, for example, to account for a reference or prior disclosure that Applicants can be unaware of at the time of the filing of the application.

For any particular compound or group disclosed herein, any name or structure (general or specific) presented is intended to encompass all conformational isomers, regioisomers, stereoisomers, and mixtures thereof that can arise from a particular set of substituents, unless otherwise specified. The name or structure also encompasses all enantiomers, diastereomers, and other optical isomers (if there are any) whether in enantiomeric or racemic forms, as well as mixtures of stereoisomers, as would be recognized by a skilled artisan, unless otherwise specified. For example, a general reference to hexane or hexanes includes n-hexane, 2-methylpentane, 3-methylpentane, 2,2-dimethylbutane, and 2,3-dimethylbutane; and a general reference to a butyl group includes an n-butyl group, a sec-butyl group, an iso-butyl group, and a t-butyl group.

The term “substituted” when used to describe a group, for example, when referring to a substituted analog of a particular group, is intended to describe the compound or group wherein any non-hydrogen moiety formally replaces hydrogen in that group or compound, and is intended to be non-limiting. A compound or group can also be referred to herein as “unsubstituted” or by equivalent terms such as “non-substituted,” which refers to the original group or compound. “Substituted” is intended to be non-limiting and include inorganic substituents or organic substituents as specified and as understood by one of ordinary skill in the art.

The terms “contact product,” “contacting,” and the like, are used herein to describe compositions and methods wherein the components are contacted together in any order, in any manner, and for any length of time, unless specified otherwise. For example, the components can be contacted by blending or mixing. Further, unless otherwise specified, the contacting of any component can occur in the presence or absence of any other component of the compositions and methods described herein. Combining additional materials or components can be done by any suitable method. Further, the term “contact product” includes mixtures, blends, solutions, slurries, reaction products, and the like, or combinations thereof. Although “contact product” can, and often does, include reaction products, it is not required for the respective components to react with one another. Similarly, “contacting” two or more components can result in a reaction product or a reaction mixture. Consequently, depending upon the circumstances, a “contact product” can be a mixture, a reaction mixture, or a reaction product.

“Conditions for aromatizing aliphatic hydrocarbons” means conditions for aromatizing at least a portion of the aliphatic hydrocarbons in a feedstock containing aliphatic hydrocarbons when contacted with a catalyst as described herein, such that the catalyst bed discharge comprises at least some aromatic hydrocarbons. Some unreacted aliphatic hydrocarbons will also be present in the catalyst bed discharge.

Generally, groups of elements are indicated using the numbering scheme indicated in the version of the periodic table of elements published in Chemical and Engineering News, 63(5), 27, 1985. In some instances, a group of elements may be indicated using a common name assigned to the group; for example, alkali metals for Group 1 elements, alkaline earth metals for Group 2 elements, transition metals for Group 3-12 elements, halogens or halides for Group 17 elements, and the like.

In one aspect, a chemical “group” may be defined or described according to how that group is formally derived from a reference or “parent” compound, for example, by the number of hydrogen atoms removed from the parent compound to generate the group, even if that group is not literally synthesized in such a manner. These groups may be utilized as substituents or coordinated or bonded to metal atoms. By way of example, an “alkyl group” formally may be derived by removing one hydrogen atom from an alkane. The disclosure that a substituent, ligand, or other chemical moiety may constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedures, unless specified otherwise or the context requires otherwise.

As used herein, the term “hydrocarbon” refers to a compound containing only carbon and hydrogen atoms. Other identifiers may be utilized to indicate the presence of particular groups, if any, in the hydrocarbon. For example, halogenated hydrocarbon indicates the presence of one or more halogen atoms replacing an equivalent number of hydrogen atoms in the hydrocarbon.

An “aromatic” compound or “aromatic hydrocarbon” is a compound containing a cyclically conjugated double bond system that follows the Hückel (4n+2) rule and contains (4n+2) pi-electrons, where n is an integer from 1 to 5. Aromatic hydrocarbons include “arenes” (aromatic compounds, for example, benzene, toluene, and xylenes) and “heteroarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2)). As disclosed herein, the term “substituted” may be used to describe an aromatic group, arene, or heteroarene, wherein a non-hydrogen moiety formally replaces a hydrogen atom in the compound, and is intended to be non-limiting, unless specified otherwise.

As used herein, the term “alkane” refers to a saturated hydrocarbon compound. Other identifiers may be utilized to indicate the presence of particular groups, if any, in the alkane (for example, halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. The alkane or alkyl group may be linear or branched unless otherwise specified.

A “cycloalkane” is used herein to refer to a saturated cyclic hydrocarbon, with or without side chains, for example, cyclobutane, cyclopentane, cyclohexane, methyl cyclopentane, and methyl cyclohexane. Other identifiers may be utilized to indicate the presence of particular groups, if any, in the cycloalkane (for example, halogenated cycloalkane indicates the presence of one or more halogen atoms replacing an equivalent number of hydrogen atoms in the cycloalkane).

An “aliphatic” compound or “aliphatic hydrocarbon” is defined according to the IUPAC recommended definition to mean an acyclic or cyclic, saturated or unsaturated carbon compound, excluding aromatic compounds. That is, an aliphatic compound is a non-aromatic organic compound.

The term “hydrocarbyl group” is used herein in accordance with the definition specified by IUPAC: a univalent group formed by removing a hydrogen atom from a hydrocarbon (that is, a group containing only carbon and hydrogen). Thus, a hydrocarbyl group includes alkyl groups (linear or branched), cycloalkyl groups, alkenyl groups, aryl groups, and the like. Non-limiting examples of hydrocarbyl groups include methyl, ethyl, butyl, hexyl, phenyl, tolyl, propenyl, and the like.

As used herein, a “paraffin” refers to a non-cyclic, linear or branched saturated hydrocarbons and includes alkanes. For example, a C₆ paraffin is a non-cyclic, linear or branched hydrocarbon having 6 carbon atoms per molecule. Normal hexane, methylpentanes, dimethylbutanes are examples of C₆ paraffins. A paraffin-containing feed comprises non-cyclic saturated hydrocarbons, such as normal paraffins, isoparaffins, and mixtures thereof.

As used herein, a “naphthene” and “naphthenic” are terms used to describe cyclic saturated hydrocarbons, and includes cycloalkanes and their alkyl-substituted analogs. Therefore, a “naphthene” is a cyclic, saturated hydrocarbon having one or more rings of carbon atoms in its chemical structure and is used herein to mean the same as “cycloalkane.” If such a cyclic structure includes unsaturated carbon-carbon bonds but is not aromatic, such compounds would be aliphatic, but not naphthenic. In some embodiments, a naphthene is a cyclic, saturated hydrocarbon having from 5 to 8 carbon atoms in the cyclic structure, including substituted (particularly alkyl-substituted) analogs thereof.

As used herein, “olefin” is an acyclic or cyclic hydrocarbon having one or more carbon-carbon double bonds, apart from the formal ones in aromatic compounds. Olefins include alkenes, cycloalkenes, and corresponding polyenes.

As used herein, “naphtha” is a petroleum distillate fraction boiling within the range of from 50° F. (10° C.) to 550° F. (260° C.). In some embodiments, naphtha boils within the range of 70° F. (21° C.) to 450° F. (232° C.), and more typically within the range of 80° F. (27° C.) to 400° F. (204° C.), and often within the range of 90° F. (32° C.) to 360° F. (182° C.). In some embodiments, at least 85 vol. % (volume percent) of naphtha boils within the range of from 50° F. (10° C.) to 550° F. (260° C.), and more typically within the range of from 70° F. (21° C.) to 450° F. (232° C.). In embodiments, at least 85 vol. % of naphtha is in the C₄ to C₁₂ range, and more typically in the C₅ to C₁₁ range, and often in the C₆ to C₁₀ range. Naphtha can include, for example, straight run naphthas, paraffinic and naphthenic raffinates from aromatic extraction or adsorption, C₆ to C₁₀ paraffin and naphthene containing feeds, bio-derived naphtha, naphtha from hydrocarbon synthesis processes, including Fischer-Tropsch and methanol synthesis processes, as well as naphtha from other refinery processes, such as hydrocracking or conventional reforming.

As used herein, the term “convertible hydrocarbon”, “convertible Co species” or “convertible C₇ species” refers to hydrocarbon compounds that may be selectively converted to aromatic products such as aromatic hydrocarbons under aromatization process conditions. In some aspects, the feed stream comprises a highly branched hydrocarbon that is not selectively converted to aromatic hydrocarbons under conventional aromatization process conditions. While a “highly branched hydrocarbon” is a hydrocarbon that is not selectively convertible to form aromatic hydrocarbons under conventional aromatization process conditions. For example, a “highly branched hydrocarbon” can comprise highly-branched hydrocarbons having six or seven carbon atoms with an internal quaternary carbon or hydrocarbons having six carbons atoms and two adjacent internal tertiary carbons or mixtures thereof. The highly branched hydrocarbons may include, but are not limited to, dimethylbutanes (for example, 2,2-dimethylbutane, 2,3-dimethylbutane), dimethylpentanes (for example, 2,2-dimethylpentane, 3,3-dimethylpentane), trimethylbutanes (for example, 2,2,3-trimethylbutane) and mixtures thereof. The highly branched hydrocarbons are not selectively convertible aromatic hydrocarbons and instead convert to light hydrocarbons under aromatization process conditions. The convertible components may comprise methylpentanes, methylhexanes, dimethylpentanes or mixtures thereof, and/or the selectively convertible components may comprise at least one of 2-methylpentane, 3-methylpentane, 2,4-dimethylpentane, 2,3-dimethylpentane, n-hexane, 2-methylhexane, 3-methylhexane, n-heptane, or mixtures thereof. The selectively convertible components readily convert to aromatic hydrocarbons without the production of light hydrocarbons.

As used herein “primary aromatic hydrocarbon,” “primary aromatic product,” “desired hydrocarbon product,” and “particular aromatic species” are used interchangeably and refer to the aromatic hydrocarbons that is the desired end product of the reaction and comprises aromatic hydrocarbons that has been generated from a feed that includes a renewable cellulose source. For example, the desired product may be benzene while toluene and xylenes may be by-products, or the desired product may be xylenes while benzene and toluene may be by-products.

A “Group 8-10” metal includes each of the Group 8 metals iron, ruthenium, and osmium, each of the Group 9 metals cobalt, rhodium, and iridium, and each of the Group metals nickel, palladium, and platinum. The Group 8-10 metals may also be referred to using the earlier nomenclature, the Group VIII metals, which also encompasses all of iron, ruthenium, osmium, cobalt, rhodium, iridium, nickel, palladium, and platinum. Generally, describing the catalyst as a Group 8-10 metal catalyst or as comprising a Group 8-10 metal, is intended to encompass catalysts that include at least one Group 8-10 metal and optionally other metals, such as Pt/Sn and Pt/Re.

The term “platinum metal” is used herein to designate the 2^{nd} and 3^{rd} row transition metals of Groups 8-10, namely, ruthenium, osmium, rhodium, iridium, palladium, and platinum.

The term “noble metal” is generally used to describe specific metals that are resistant to corrosion and this term is used herein to include certain 2^{nd} and 3^{rd} row transition metals, but no first row transition metals. Generally, noble metals include ruthenium, osmium, rhodium, iridium, palladium, platinum, silver, and gold. Accordingly, the Group 8-10 noble metals are also the platinum metals.

As used herein, the term “bound”, is intended to describe a zeolite-binder combination or other support-binder combination that is formed into aggregates such as pellets, pills, extrudates and the like. The term “catalyst base”, as used herein, refers to a bound zeolite or bound support.

The term “catalyst” is used herein in a broad sense and includes the final catalyst as well as precursors of the final catalyst. Precursors of the final catalyst include, for example, the calcined form of the catalyst containing the catalytic metal and also the catalyst prior to activation by reduction. The term “catalyst” is thus used to refer to the activated catalyst in some contexts herein, and in other contexts to refer to precursor forms of the catalyst, as will be understood by skilled persons from the context.

The term “sulfur sensitive” describes catalysts that are particularly sensitive to the presence of sulfur in the feedstock. Generally, these catalysts require the amount of sulfur in the feedstock to be reduced to less than 5 ppm by hydrotreating, adsorbents, or a combination thereof. As used herein the terms “aromatization reactor system,” “aromatization reactor unit,” “catalytic reactor system,” and “catalytic reactor unit” when referring to aromatization reactor systems also refer to the reactor vessel, reactor internals, and associated processing equipment as the context allows, including but not limited to the catalyst, inert packing materials, scallops, flow distributors, center pipes, reactor ports, catalyst transfer and distribution system, furnaces and other heating devices, heat transfer equipment, and piping. The aromatization reactor system described may comprise a fixed catalyst bed system, a moving catalyst bed system, a fluidized catalyst bed system, or combinations thereof. Such aromatization reactor systems may be batch or continuous. In a fixed bed system, the flow of the feed can be upward, downward, or radially through the reactor. In an aspect, the first catalyst bed, the intermediate catalyst beds, and the last catalyst bed are in a radial flow reactor.

The term “catalyst bed”, such as first, second, or intermediate catalyst bed, is used herein to refer to a specific catalyst composition which constitutes at least a portion of, or all of, the catalyst material in a single aromatization reactor. For example, a “first catalyst bed” can occupy the entirety of one aromatization reactor, or it can occupy a portion of one aromatization reactor while a “second catalyst bed” occupies the remaining portion of the aromatization reactor. More typically, each catalyst bed can occupy the entirety of one aromatization reactor. Generally, and unless specified otherwise or the context requires otherwise, multiple aromatization reactors are described as having different catalyst beds, regardless of whether their catalysts have identical or different compositions.

The term “halogen” has its usual meaning and, as the context allows, includes halides. Therefore, examples of halogens include fluorine, fluoride, chlorine, chloride, bromine, bromide, iodine, and iodide. Further, the use of the term “fluoride” and “chloride” when describing the catalyst components or catalyst composition such as weight percentage or mole percentage of these components, does not depend on their presence in the catalyst in any particular molecular or ionic form.

Molar selectivities are defined as follows:

$$Benzene selectivity : {S}_{Bz} = \frac{{\dot{n}}_{Bz , prod}}{{\dot{n}}_{conv C 6 , feed} - {\dot{n}}_{conv C 6 , prod}} \qquad Eq . 1$$

$$Toluene selectivity : {S}_{Tol} = \frac{{\dot{n}}_{Tol , prod}}{{\dot{n}}_{conv C 7 , feed} - {\dot{n}}_{conv C 7 , prod}} \qquad Eq . 2$$

$$Benzene + Toluene selectivity : {S}_{Bz + Tol} = \frac{{\dot{n}}_{Bz , prod} + {\dot{n}}_{tol , prod}}{{\dot{n}}_{conv C 6 , C 7 , feed} - {\dot{n}}_{conv C 6 , C 7 , prod}} \qquad Eq . 3$$

$$Aromatics selectivity : {S}_{arom} = \frac{{\dot{n}}_{Bz , prod} + {\dot{n}}_{Tol , prod} + {\dot{n}}_{CB + arom , prod}}{{\dot{n}}_{convC 6 - C 8 + , feed} - {\dot{n}}_{convC 6 - C 8 + , prod}} \qquad Eq . 4$$

Conversion is defined as the number of moles converted per mole of “convertible” hydrocarbons fed as follows:

$${C}_{6} conversion : {X}_{C 6} = \frac{{\dot{n}}_{convC 6 , feed} - {\dot{n}}_{convC 6 , prod}}{{\dot{n}}_{convC 6 , feed}} \qquad Eq . 5$$

$${C}_{7} conversion : {X}_{C 7} = \frac{{\dot{n}}_{convC 7 , feed} - {\dot{n}}_{convC 7 , prod}}{{\dot{n}}_{convC 7 , feed}} \qquad Eq . 6$$

$${C}_{6} + {C}_{7} conversion : {X}_{C 6 + C 7} = \frac{{\dot{n}}_{convC 6 , feed} + {\dot{n}}_{convC 7 , feed} - {\dot{n}}_{convC 6 , prod} - {\dot{n}}_{convC 7 , prod}}{{\dot{n}}_{convC 6 , feed} + {\dot{n}}_{convC 7 , feed}} \qquad Eq . 7$$

In these equations, n indicates a molar flow rate in a continuous reactor or the number of moles in a batch reactor.

A “tonne” is used herein to refer to a metric ton, that is, a unit of mass equal to 1,000 kilograms.

The Abstract of this application is not intended to be used to construe the scope of the claims or to limit the scope of the subject matter that is disclosed herein, but rather to satisfy the requirements of 37 C.F.R. § 1.72(b), to enable the United States Patent and Trademark Office and the public generally to determine quickly from a cursory inspection the nature and gist of the technical disclosure. Moreover, any headings that are employed herein are also not intended to be used to construe the scope of the claims or to limit the scope of the subject matter that is disclosed herein. Any use of the past tense to describe any example otherwise indicated as constructive or prophetic is not intended to reflect that the constructive or prophetic example has actually been carried out.

All publications and patents mentioned herein are incorporated herein by reference in their entireties for the purpose of describing and disclosing, for example, the constructs and methodologies that are described in the publications, which might be used in connection with the presently described invention. The publications discussed throughout the text are provided solely for their disclosure prior to the filing date of the present application. Nothing herein is to be construed as an admission that the inventors are not entitled to antedate such disclosure by virtue of prior invention.

Those skilled in the art will readily appreciate that many modifications are possible in the exemplary embodiments disclosed herein without materially departing from the novel teachings and advantages according to this disclosure. Accordingly, all such modifications and equivalents are intended to be included within the scope of this disclosure as defined in the following claims. Therefore, it is to be understood that resort can be had to various other aspects, embodiments, modifications, and equivalents thereof which, after reading the description herein, may suggest themselves to one of ordinary skill in the art without departing from the spirit of the present disclosure or the scope of the appended claims.

### DETAILED DESCRIPTION

The present disclosure is directed generally to methods of regenerating and/or reactivating spent catalysts, such as spent aromatization catalysts. It has been unexpectedly discovered that by using a fluorine-containing compound, instead of fluorine gas, during a fluorination step, the methods herein can achieve improved distribution of fluorine across a catalyst bed, with little or no impact on the performance of the regenerated and/or reactivated catalysts.

Any spent catalyst may be subjected to the methods described herein. In some embodiments, a spent catalyst includes a transition metal and a catalyst support. A catalyst, such as a spent catalyst, may be present in a metal reactor during some or all of the steps of the methods provided herein. In some embodiments, the metal reactor includes stainless steel, e.g., 347SS or 321SS.

### Methods

Reforming methods are provided herein, which may include any two or more (such as any two, any three, any four, any five, any six, any seven, or all eight) of the following steps: (A) contacting a hydrocarbon feed with an aromatization catalyst including a transition metal and a catalyst support under reforming conditions in a metal reactor system to produce an aromatic product; (B) performing step (A) for a time period sufficient to form a spent catalyst; (C) contacting the spent catalyst with hydrogen gas to produce a stripped spent catalyst; (D) subjecting the stripped spent catalyst to a carbon burn at a temperature, such as a temperature not exceeding about 500° F., for a time effective to remove from the spent catalyst at least a portion of the hydrogen carbon feed, at least a portion of the aromatic product, or a combination thereof to form a treated spent catalyst; (E) contacting the treated spent catalyst with a chlorine-containing stream including a chlorine-containing compound to produce a chlorinated spent catalyst; (F) subjecting the chlorinated spent catalyst to a carbon burn at a temperature, such as a temperature not exceeding 900° F., for a time effective to improve a dispersion of the transition metal in the chlorinated spent catalyst to form a redistributed spent catalyst; (G) contacting the redistributed spent catalyst with a fluorine-containing stream comprising a fluorine-containing compound to form a regenerated catalyst; and (H) reducing the regenerated catalyst. The methods herein also may include a step of reactivating the catalyst, such as after step (H). In some embodiments, the reforming methods herein are in situ processes. Therefore, in some embodiments, steps (A)-(H) (or the two or more of steps (A)-(H) that are selected) are performed in the same reactor system. In some embodiments, steps (C)-(H) are performed externally to a reactor system in which steps (A)-(B) are performed. For example, steps (C)-(H) may be performed in a metal reactor that is not in the reforming reactor system.

In some embodiments, the methods include (1) contacting the spent catalyst with hydrogen gas to produce a stripped spent catalyst; (2) subjecting the stripped spent catalyst to a carbon burn at a temperature, such as a temperature not exceeding about 500° F., for a time effective to remove from the spent catalyst at least a portion of the hydrogen carbon feed, at least a portion of the aromatic product, or a combination thereof to form a treated spent catalyst; (3) contacting the treated spent catalyst with a chlorine-containing stream including a chlorine-containing compound to produce a chlorinated spent catalyst; (4) subjecting the chlorinated spent catalyst to a carbon burn at a temperature, such as a temperature not exceeding 900° F., for a time effective to improve a dispersion of the transition metal in the chlorinated spent catalyst to form a redistributed spent catalyst; (5) contacting the redistributed spent catalyst with a fluorine-containing stream including a fluorine-containing compound to form a regenerated catalyst; and (6) reducing the regenerated catalyst.

In some embodiments, the methods include (A) contacting a hydrocarbon feed with an aromatization catalyst including a transition metal and a catalyst support under reforming conditions in a metal reactor system to produce an aromatic product; (B) performing step (A) for a time period sufficient to form a spent catalyst; (C) contacting the spent catalyst with a chlorine-containing stream comprising a chlorine-containing compound to produce a chlorinated spent catalyst, wherein, optionally, the chlorine-containing compound comprises chlorine, a chlorinated hydrocarbon, a chlorofluorocarbon (CFC), a hydrochlorofluorocarbon (HCFC), or a combination thereof; (D) contacting the chlorinated spent catalyst with a decoking gas stream comprising oxygen to produce a de-coked catalyst; and (E) contacting the de-coked catalyst with a fluorine-containing stream including a fluorine-containing compound, wherein the fluorine-containing compound includes a hydrofluorocarbon (HFC), a chlorofluorocarbon (CFC), a hydrochlorofluorocarbon (HCFC), a fluorocarbon (FC), or a combination thereof. In some embodiments, the methods are in situ processes. For example, steps (A)-(E) may be performed in the same reactor system. In some embodiments, steps (C)-(E) are performed externally to the reactor system of steps (A)-(B). For example, steps (C)-(E) may be performed in a metal reactor that is not in the reforming reactor system. In some embodiments, the methods include reactivating the catalyst after step (E).

In some embodiments, the methods include regenerating a spent catalyst that includes a transition metal and a catalyst support in a metal reactor. The methods may include (1) contacting the spent catalyst with a chlorine-containing stream comprising a chlorine-containing compound to produce a chlorinated spent catalyst; (2) contacting the chlorinated spent catalyst with a decoking gas stream comprising oxygen to produce a de-coked catalyst; and (3) contacting the de-coked catalyst with a fluorine-containing stream comprising a fluorine-containing compound to produce a regenerated catalyst, wherein the fluorine-containing compound includes a hydrofluorocarbon (HFC), a chlorofluorocarbon (CFC), a hydrochlorofluorocarbon (HCFC), a fluorocarbon (FC), or a combination thereof.

The steps of the methods provided herein generally may be performed at any effective time period, temperature, pressure, etc.

### Hydrogen Gas

The contacting of a spent catalyst with hydrogen gas may occur at any effective temperature. In some embodiments, the contacting of a spent catalyst with hydrogen gas occurs, at least in part, at a temperature greater than 25° F., greater than 100° F., greater than 200° F., greater than 300° F., greater than 400° F., or greater than 500° F. In some embodiments, the contacting of a spent catalyst with hydrogen gas occurs, at least in part, at a temperature of about 300° F. to about 800° F., about 400° F. to about 800° F., or about 500° F. to about 800° F.

The contacting of a spent catalyst with hydrogen may occur for any effective time. In some embodiments, the contacting of a spent catalyst with hydrogen gas occurs for a time of about 1 minute to about 24 hours, about 1 minute to about 18 hours, about 1 minute to about 12 hours, about 1 minute to about 6 hours, or about 1 minute to about 2 hours.

### Fluorine-Containing Compounds and Streams

The fluorine-containing compounds used in the methods described herein may include any compound, in any phase, that includes in its structure one or more fluorine atoms. For example, a fluorine-containing compound may include a hydrofluorocarbon (HFC), a chlorofluorocarbon (CFC), a hydrochlorofluorocarbon (HCFC), a fluorocarbon (FC), or a combination thereof. In some embodiments, the fluorine-containing compound is a compound of formula (I) —

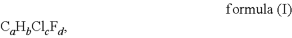

wherein a is 1 to 6, b is 0 to 14, c is 0 to 14, d is 1 to 14, wherein, optionally, b and/or c is not 0, wherein b+c+d=2a+2, and wherein, optionally, the compound of formula (I) is substituted. In some embodiments, the fluorine-containing compound is 1,1,1,2-tetrafluoroethane. In some embodiments, the fluorine-containing compound is difluoromethane. In some embodiments, the fluorine-containing compound is dichlorodifluoromethane.

The fluorine-containing compounds may be a component of a fluorine-containing stream. A fluorine-containing stream may consist of one or more fluorine-containing compounds, such as one, two, three, etc. fluorine-containing compounds. A fluorine-containing stream may include at least one component other than the one or more fluorine-containing compounds. The at least one component other than the one or more fluorine-containing compounds may be a fluid, such as an inert gas, air, oxygen gas, etc. In some embodiments, the fluorine-containing stream includes (i) a fluorine-containing compound and any inert gas disclosed herein, for example, nitrogen, (ii) a fluorine-containing compound, any inert gas disclosed herein, and air, (iii) a fluorine-containing compound and air, or (iv) a fluorine-containing compound, oxygen (O₂), and any inert gas disclosed herein, for example, nitrogen.

One or more fluorine-containing compounds may be present in a fluorine-containing stream at any concentration and/or ratio. When two or more components other than fluorine-containing compound(s) are present in a fluorine-containing stream, the two or more components may be present at any concentration and/or ratio (volume ratio or weight ratio). For example, a fluorine-containing stream may include an inert gas and air, and the inert gas and air may be present at a volume ratio of about 3:1 to about 30:1, about 3:1 to about 20:1, about 3:1 to about 10:1, about 3:1 to about 5:1, or about 4:1. As a further example, a volume ratio of an inert gas to oxygen (O₂) in a fluorine-containing stream may be about 90:10 to about 99.9:0.1, about 95:5 to about 99:1, or about 97:3 (inert gas:oxygen (O₂)). In some embodiments, a fluorine-containing stream includes from about 0.01 mol % to about 40 mol %, about 0.01 mol % to about 30 mol %, about 0.01 mol % to about 20 mol %, about 0.01 mol % to about 10 mol %, or about 0.01 mol % to about 5 mol % of oxygen. The oxygen (O₂) may be a component of air.

A fluorine-containing stream may be formed with the aid of any known equipment, and the components of a fluorine-containing stream may be combined in any manner and/or order, such as simultaneously, sequentially, etc. In some embodiments, the contacting of a redistributed spent catalyst with a fluorine-containing stream includes circulating a fluid, such as an inert gas, and injecting a fluorine-containing compound into the circulating fluid. In some embodiments, the injecting of a fluorine-containing compound is achieved, at least in part, with a spraying apparatus, such as a spraying apparatus configured to disperse the fluorine-containing compound in a circulating fluid, such as an inert gas, oxygen, or a combination thereof. For example, the contacting of a redistributed spent catalyst with a fluorine-containing stream may include circulating a stream that includes an inert gas and oxygen (O₂), and injecting the fluorine-containing compound into the circulating stream. A circulating stream may include oxygen (O₂) at any concentration. In some embodiments, oxygen (O₂) is present in a circulating stream at a concentration of about 0.01% to about 10%, about 0.01% to about 8%, about 0.01% to about 6%, about 0.01% to about 4%, about 1% to about 4%, about 2% to about 4%, about 2.5% to about 3.5%, or about 3%, by volume.

A catalyst, such as a redistributed spent catalyst may be contacted with a fluorine-containing compound or a fluorine-containing stream in any manner and under any conditions effective to place on the catalyst a desired weight percentage of fluorine, such as a weight percentage of up to 3%, up to 2%, or up to 1%.

In some embodiments, the contacting of a spent catalyst, such as the redistributed spent catalyst, with a fluorine-containing stream includes (a) providing two or more reactors in fluid communication with each other, wherein the two or more reactors are connected in a series, thereby permitting a fluorine-containing stream to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors, wherein each of the two or more reactors includes a reservoir in which the spent catalyst is disposed; (b) heating one of the two or more reactors to a temperature that is equal to or greater than a fluorination temperature, and maintaining each of the remaining reactors of the two or more reactors at a temperature less than the fluorination temperature, wherein the fluorination temperature is effective to at least partially decompose a fluorine-containing compound of the fluorine-containing stream; and (c) injecting the fluorine-containing stream and circulating or recirculating the fluorine-containing stream for a time effective to achieve a desired level of fluorination of the spent catalyst in the one of the two or more reactors at the temperature that is equal to or greater than the fluorination temperature.

When the systems and methods herein includes a group of components, such as reactors, that are connected in a series, the component arbitrarily referred to as the “first” is the component that is the furthest upstream, and the remaining components are numbered sequentially thereafter, with the highest number arbitrarily assigned to the component that is downstream of all of the other components in the group. For example, if a system includes three reactors, the “first” reactor is upstream of the “second” and “third” reactors, and the “third” reactor is downstream of the “first” and “second” reactors. Therefore, if a limitation herein recites that a stream is “returned to a first of the two or more reactors”, then this limitation indicates that the stream is passed to the reactor that is upstream of the other “two or more reactors”.

The methods also may include heating a different one of the two or more reactors to a temperature that is equal to or greater than the fluorination temperature, and maintaining each of the remaining reactors of the two or more reactors at a temperature less than the fluorination temperature; and injecting the fluorine-containing stream and circulating or recirculating the fluorine-containing stream for a time effective to achieve a desired level of fluorination of the spent catalyst in the different one of the two or more reactors at the temperature that is equal to or greater than the fluorination temperature. These elements may be repeated until the spent catalyst in each of the one or more reactors is fluorinated to the desired level.

A fluorine-containing stream may be circulated once through the two or more reactors, or the fluorine-containing stream may be recirculated any number of times through the two or more reactors. The recirculation may be continue until a desirable concentration of fluorine is placed on the catalyst.

A fluorination temperature may include any temperature at which a fluorine-containing compound at least partially decomposes. In some embodiments, the temperature that is equal to or greater than the fluorination temperature is at least 700° F. In some embodiments, the temperature that is equal to or greater than the fluorination temperature is about 650° F. to about 850° F., about 700° F. to about 850° F., about 700° F. to about 800° F., about 700° F. to about 775° F., or about 700° F. to about 750° F. In some embodiments, the temperature that is less than the fluorination temperature is about 600° F. or less. In some embodiments, the temperature that is less than the fluorination temperature is about 300° F. to about 600° F., about 400° F. to about 600° F., or about 500° F. to about 600° F.

A fluorine-containing stream may be introduced into the two or more reactors in any manner. In some embodiments, a fluorine-containing stream is injected. The injecting of the fluorine-containing stream may include (1) selecting an injection point from one or more injection points, and (2) injecting the fluorine-containing stream in the injection joint selected from the one or more injection points. The selected injection point may be any of those present in the systems provided herein. In some embodiments, the selected injection point is (i) upstream of the one reactor (or the different reactor) heated to the temperature that is equal to or greater than the fluorination temperature, (ii) downstream of all other reactors upstream of the reactor (or the different reactor) heated to the temperature that is equal to or greater than the fluorination temperature, or (iii) a combination thereof.

The amount of the fluorine-containing compound or the fluorine-containing stream that is injected and circulated/recirculated may be effective to place on the spent catalyst any amount of fluorine, such as about 0.1 wt % to about 1.5 wt % of fluorine, about 0.5 wt % to about 1.5 wt % of fluorine, or about 0.15 wt % to about 1.2 wt % of fluorine. The methods may include analyzing the fluorine-containing stream during the circulating or recirculating of the fluorine-containing stream to determine an amount or concentration of the fluorine-containing compound and/or fluorine in the fluorine-containing stream. The methods may include stopping the circulating/recirculating of the fluorine-containing stream when the amount or concentration of the fluorine-containing compound and/or fluorine is at or below a threshold concentration or amount that indicates successful deposition of fluorine on the spent catalyst. The monitoring of the fluorine-containing stream may be achieved using any known technique or apparatus, such as spectroscopy.

Also provided herein are systems for fluorinating a spent catalyst. The systems may include (a) two or more reactors in fluid communication with each other, wherein the two or more reactors are connected in a series, thereby permitting a fluid stream, such as a fluorine-containing stream, to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors; and (b) two or more heating apparatuses configured to heat each of the two or more reactors to the same or different temperatures.

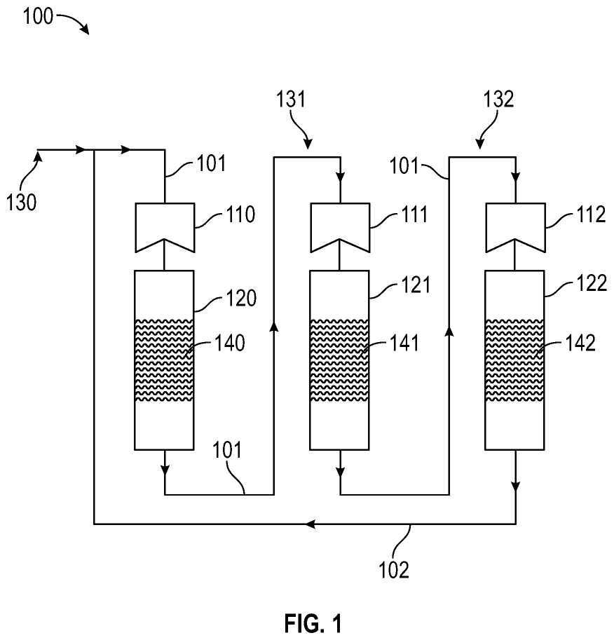

An embodiment of a system is depicted at FIG. 1. The system 100 includes a first furnace 110 configured to heat a first reactor 120, a second furnace 111 configured to heat a second reactor 121, and a third furnace 112 configured to heat a third reactor 122, wherein these components are connected in a series via piping 101, which includes a “feedback loop” 102 that allows a circulating stream to be recirculated from the third reactor 122 to the first reactor 110. Although three reactor/furnace pairs (110/120, 111/121, 112/122) are depicted at FIG. 1, the systems may include two, three four, five, six, seven, eight, nine, ten, or more reactors. The system 100 of FIG. 1 includes three possible points of injection (130, 131, 132), which are upstream of the first reactor 120, second reactor 121, and third reactor 122, respectively. Furnaces having configurations other than those depicted at FIG. 1 may be used, such as tube furnaces or others.

The system 100 of FIG. 1 may be used to perform embodiments of the methods provided herein. For example, in some embodiments, the methods include (i) heating reactor 120 with furnace 110 to a temperature of about 700° F. to about 850° F., (ii) keeping the temperatures of the second reactor 121 and the third reactor 122 at or below about 600° F., (iii) injecting a fluorine-containing stream at the first point of injection 130, and circulating or recirculating the fluorine-containing stream through the first 120, second 121, and third 122 reactors for a time effective to deposit a desired level of fluorine on the spent catalyst 140 of the first reactor 120. The methods also may include (i) reducing the temperature of the first reactor 120 to a temperature of about 600° F. or less, (ii) using the furnace 111 to increase the temperature of the second reactor 121 to a temperature of about 700° F. to about 850° F., (iii) keeping the temperatures of the first reactor 120 and the third reactor 122 at or below about 600° F., and (iv) injecting a fluorine-containing stream at the second point of injection 131, and circulating or recirculating the fluorine-containing stream through the second 121, third 122, and first 120 reactors for a time effective to deposit a desired level of fluorine on the spent catalyst 141 of the second reactor 121. The methods also may include (i) reducing the temperature of the second reactor 121 to a temperature of about 600° F. or less, (ii) using the furnace 112 to increase the temperature of the third reactor 122 to a temperature of about 700° F. to about 850° F., (iii) keeping the temperatures of the first reactor 120 and the second reactor 121 at or below about 600° F., and (iv) injecting a fluorine-containing stream at the third point of injection 132, and circulating or recirculating the fluorine-containing stream through the third 122, first 120, and second 121 reactors for a time effective to deposit a desired level of fluorine on the spent catalyst 142 of the second reactor 122.

In some embodiments, (i) an amount of fluorine-containing compound in a fluorine-containing stream, (ii) a duration of the contacting of the spent catalyst with the fluorine-containing stream, or (iii) a combination thereof is selected to place on the redistributed spent catalyst about 0.1 wt % to about 2 wt %, about 0.15 wt % to about 1.5 wt %, about 0.2 wt % to about 1.5 wt %, about 0.2 wt % to about 1 wt %, about 0.5 wt % to about 1.5 wt %, about 0.5 wt % to about 1 wt %, or about 0.8 wt % to about 1 wt % of fluorine. In some embodiments, the contacting of a catalyst, such as a spent catalyst, and the fluorine-containing stream occurs, at least partially, at a temperature of about 500° F. to about 1,000° F., about 600° F. to about 1,000° F., about 600° F. to about 900° F., about 700° F. to about 900° F., or about 700° F. to about 850° F. In some embodiments, the amount of fluorine-containing compound in the fluorine-containing stream is controlled to give a desired concentration of fluorine [F] on the catalyst, such as a concentration less than any maximum amount or in any range disclosed herein, for example, less than about 10 wt %, less than about 8 wt %, less than about 6 wt %, less than about 4 wt %, less than about 2 wt %, less than 1.5 wt %, in a range from about 0.1 wt % to about 3 wt %, about 1 wt % to about 2 wt %, about 1.25 wt % to about 1.75 wt %, about 0.1 wt % to about 1.5 wt %, about 0.15 wt % to about 1.3 wt %, about 0.1 wt % to about 1.0 wt %, about 0.25 wt % to about 3 wt %, about 0.25 wt % to about 2 wt %, about 0.25 wt % to about 1.75 wt %, about 0.25 wt % to about 1.5 wt %, about 0.25 wt % to about 1.3 wt %, about 0.25 wt % to about 1.0 wt %, about 0.5 wt % to about 1 wt %, or about 0.3 wt % to about 0.8 wt %. In some embodiments, a fluorination step is conducted at (i) a fluorination temperature in any fluorination temperature range disclosed herein, for example, from about 0° C. to about 600° C., from about 10° C. to about 550° C., from about 20° C. to about 450° C., from about 0° C. to about 300° C., from about 20° C. to about 250° C., or from about 15° C. to about 50° C., (ii) a fluorination pressure of atmospheric pressure to about 15 bar, atmospheric pressure to about 10 bar, atmospheric pressure to about 7 bar, about 2 bar to about 10 bar, about 2 bar to about 5 bar, or about 2 bar. In some embodiments, a fluorination step is conducted for a time period in any range of fluorination time periods disclosed herein, for example, from about 0.1 hours to about 96 hours, about 0.1 hours to about 72 hours, about 0.1 to about 48 hours, from about 0.1 to about 12 hours, or from about 0.1 to about 8 hours.

In some embodiments, the amount of fluorine-containing compound in the fluorine-containing stream is controlled to give a concentration of fluorine [F] or a fluorine-containing compound, such as a concentration in a fluorine-containing stream, less than any maximum amount or in any range disclosed herein, for example, less than about 50,000 ppmv, in a range from about 5 to about 25,000 ppmv, in a range from about 10 to about 25,000 ppmv, in a range from about 50 to about 25,000 ppmv, in a range from about 5,000 to about 25,000 ppmv, in a range from about 50 to about 20,000 ppmv, in a range from about 50 to about 15,000 ppmv, in a range from about 50 to about 10,000 ppmv, in a range from about 50 to about 5,000 ppmv, in a range from about 50 to about 2,500 ppmv, in a range from about 50 to about 1,000 ppmv, in a range from about 500 to about 1,000 ppmv, in a range from about 600 to about 900 ppmv, in a range from about 700 to about 800 ppmv, or about 750 ppmv.

In some embodiments, a concentration of fluorine in the regenerated catalyst is about 0.15 wt % to about 1.2 wt %, or about 0.2 wt % to about 1.2 wt %. In some embodiments, a concentration gradient of fluorine in a regenerated catalyst is 60% or less, 50% or less, 40% or less, 30% or less, 20% or less, or 10% or less.

Generally, a fluorine-containing stream may include any of the compounds, gasses, etc. described herein, and any one or more of the compounds, gasses, etc. described herein may be excluded from a fluorine-containing stream. For example, a fluorine-containing stream may be substantially free of oxygen-containing compounds and/or chlorine-containing compounds that do not include a fluorine atom. A fluorine-containing stream is considered “substantially free” of a compound when the compound is present in a fluorine-containing stream at a concentration of less than about 100 ppmw, less than about 50 ppmw, or less than about 25 ppmw.

The methods provided herein also may include recovering at least a portion of the fluorine-containing stream to produce a recovered fluorine-containing stream. The recovering of at least a portion of the fluorine-containing stream may occur after the contacting of a de-coked catalyst with the fluorine-containing stream. The methods also may include contacting the de-coked catalyst with the recovered fluorine-containing stream.

### Chlorine-Containing Compounds and Streams

The chlorine-containing compounds used in the methods described herein may include any compound, in any phase, that includes in its structure one or more chlorine atoms. In some embodiments, the chlorine-containing compound includes chlorine gas (Cl₂). A chlorine-containing stream may include one or more compounds (e.g., an inert gas) other than a chlorine-containing compound. In some embodiments, the chlorine-containing stream includes chlorine gas (Cl₂) and an inert gas, such as nitrogen (N₂). In some embodiments, the chlorine-containing compounds include hydrochloric acid, chlorine gas (Cl₂), carbon tetrachloride, tetrachloroethylene, chlorobenzene, methyl chloride, methylene chloride, chloroform, allyl chloride, trichloroethylene, a chloramine, a chlorine oxide, a chlorine acid, chlorine dioxide, dichlorine monoxide, dichlorine heptoxide, chloric acid, perchloric acid, ammonium chloride, tetramethylammonium chloride, tetraethylammonium chloride, tetrapropylammonium chloride, tetrabutylammonium chloride, methyltriethylammonium chloride, or any combination thereof.

A chlorine-containing stream may be formed with the aid of any known equipment, and the components of a chlorine-containing stream may be combined in any manner and/or order, such as simultaneously, sequentially, etc. For example, the methods herein may include circulating a fluid, such as an inert gas, and injecting a chlorine-containing compound into the circulating fluid. The injecting of a chlorine-containing compound may be achieved, at least in part, with a spraying apparatus configured to disperse the chlorine-containing compound in the circulating inert gas.

In some embodiments, the amount of chlorine-containing compound in the chlorine-containing stream is controlled to give a desired concentration of chlorine (Cl) or chlorine-containing compound, such as less than any maximum amount or in any range disclosed herein, for example, less than about 50,000 ppmv, in a range from about 5 to about 25,000 ppmv, in a range from about 10 to about 25,000 ppmv, in a range from about 50 to about 25,000 ppmv, in a range from about 50 to about 20,000 ppmv, in a range from about 50 to about 15,000 ppmv, in a range from about 50 to about 10,000 ppmv, in a range from about 50 to about 5,000 ppmv, in a range from about 50 to about 2,500 ppmv, in a range from about 50 to about 1,000 ppmv, in a range from about 50 to about 500 ppmv, in a range from about 50 to about 100 ppmv, in a range from about 100 to about 750 ppmv, or in a range from about 500 to about 600 ppmv.

A catalyst may be contacted with a chlorine-containing compound or a chlorine-containing stream in any manner and under any conditions effective to place on the catalyst a desired weight percentage of chlorine or the chlorine-containing compound, such as a weight percentage of up to 3%, up to 2%, or up to 1%. In some embodiments, (i) the amount of chlorine-containing compound in the chlorine-containing stream, (ii) the duration of the contacting of the treated spent catalyst and the chlorine-containing stream, or (iii) a combination thereof is controlled to place on the treated spent catalyst about 0.1 wt % to about 2 wt %, about 0.5 wt % to about 1.5 wt %, about 0.5 wt % to about 1 wt %, or 0.6 wt % to about 1 wt % of chlorine or the chlorine-containing compound.

Generally, a chlorine-containing stream may include any of the compounds, gasses, etc. described herein, and any one or more of the compounds, gasses, etc. described herein may be excluded from a chlorine-containing stream. For example, a chlorine-containing stream may be substantially free of oxygen-containing compounds and/or fluorine-containing compounds. A chlorine-containing stream is considered “substantially free” of a compound when the compound is present in a chlorine-containing stream at a concentration of less than about 100 ppmw, less than about 50 ppmw, or less than about 25 ppmw.

A catalyst may be contacted with a chlorine-containing compound or chlorine-containing stream in any manner and under any conditions (e.g., temperature, pressure, etc.). In some embodiments, the chlorination step is conducted at a chlorination temperature in any chlorination temperature range disclosed herein, for example, from about 0° F. to about 600° F., from about 100° F. to about 600° F., from about 200° F. to about 600° F., from about 300° F. to about 600° F., from about 400° F. to about 600° F., from about 400° F. to about 500° F., or from about 400° F. to about 450° F. In some embodiments, the chlorination step is conducted for a time period in any range of chlorination time periods disclosed herein, for example, from about 0.5 hours to about 72 hours, from about 0.75 hours to about 60 hours, from about 1 to about 48 hours, from about 1 to about 12 hours, or from about 2 to about 8 hours. In some embodiments, the chlorination step is conducted at a chlorination temperature of from about 0° F. to about 600° F., from about 100° F. to about 600° F., from about 200° F. to about 600° F., from about 300° F. to about 600° F., from about 300° F. to about 500° F., from about 350° F. to about 500° F., or from about 350° F. to about 450° F. In some embodiments, the chlorination step is conducted for a time period in any range of chlorination time periods disclosed herein, for example, from about 0.10 hours to about 72 hours, from about 0.50 hours to about 60 hours, from about 0.5 to about 48 hours, from about 0.5 to about 12 hours, or from about 1 to about 8 hours.

### Decoking Gas Streams

A decoking gas stream may include any of those known in the art. In some embodiments, a decoking gas stream includes any combination of an inert gas (one or more) and oxygen disclosed herein, for example, a mixture of nitrogen and oxygen, air, or a mixture of air and nitrogen.

A concentration of oxygen in a decoking gas stream may be limited. In some embodiments, a decoking gas stream includes a mole % of oxygen less than any maximum amount or in any range disclosed herein, for example, less than about 5 mole %, in a range from about 0.1 to about 10 mole %, in a range of about 0.1 to about 8 mole %, in a range from about 0.1 to about 5 mole %, in a range from about 0.5 to about 3 mole %, or in a range from about 0.5 to about 6 mole %.

A decoking gas stream may include any one or more of the compounds disclosed herein, or any one or more of the compounds disclosed herein may be excluded from a decoking gas stream. In some embodiments, a decoking gas stream is substantially free of halogen-containing compounds, such as added halogen-containing compounds (e.g., substantially halogen-free, substantially chlorine-free). A decoking gas stream is “substantially free” of a halogen-containing compound when the halogen-containing compound is present at a concentration of less than about 100 ppmw, less than about 50 ppmw, or less than about 25 ppmw. In some embodiments, a decoking gas stream is substantially free of water (e.g., added water). A decoking gas stream is “substantially free” of water when water is present at a concentration of less than about 100 ppmw, less than about 50 ppmw, or less than about 25 ppmw.

### Carbon Burning

The carbon burning steps of the methods provided herein may be conducted under any effective conditions (e.g., temperature, time, etc.). In some embodiments, the temperature of the carbon burning of a catalyst, such as a stripped spent catalyst, is about 300° F. to about 600° F., about 350° F. to about 550° F., about 350° F. to about 500° F., about 400° F. to about 475° F. In some embodiments, the temperature of the carbon burning of a catalyst, such as a chlorinated spent catalyst, is about 500° F. to about 1,200° F., about 500° F. to about 1,100° F., about 500° F. to about 1,000° F., about 600° F. to about 1,000° F., about 700° F. to about 1,000° F., about 700° F. to about 900° F., about 800° F. to about 900° F., or about 850° F. In some embodiments, a carbon burn step is conducted at a peak decoking temperature in any peak decoking temperature range disclosed herein, for example, from about 100° C. (about 212° F.) to about 700° C. (about 1,292° F.), from about 125° C. (about 257° F.) to about 650° C. (about 1,202° F.), from about 150° C. (302° F.) to about 600° C. (about 1,112° F.), from about 200° C. (about 392° F.) to about 500° C. (about 932° F.), or from about 350° C. (about 662° F.) to about 450° C. (about 842° F.). In some embodiments, a carbon burn step is started at an initial decoking temperature which is the same as any chlorine purging temperature disclosed herein, for example, from about 0° C. (about 32° F.) to about 300° C. (about 572° F.), from about 20° C. (about 68° F.) to about 275° C. (about 527° F.), from about 20° C. (about 68° F.) to about 250° C. (about 482° F.), or from about 50° C. (about 122° F.) to about 200° C. (about 392° F.).

The carbon burning of the stripped spent catalyst may occur for a time of about 1 minute to about 24 hours, about 1 minute to about 18 hours, about 1 minute to about 12 hours, about 1 minute to about 6 hours, or about 1 minute to about 2 hours. In some embodiments, the carbon burning of a catalyst, such as a chlorinated spent catalyst, occurs for a time of about 1 minute to about 24 hours, about 1 minute to about 18 hours, about 1 minute to about 12 hours, about 1 minute to about 6 hours, or about 1 minute to about 2 hours. In some embodiments, the carbon burn step is conducted for a time period in any range of de-coking time periods disclosed herein, for example, from about 0.5 hours to about 120 hours, from about 0.75 hours to about 108 hours, from about 1 hour to about 96 hours, from about 1 to about 72 hours, from about 12 to about 48 hours, or from about 1 to about 6 hours.

A carbon burning step may remove any desired amount of a hydrocarbon feed and/or aromatic feed from a catalyst. For example, the carbon burning of a catalyst, such as a stripped spent catalyst, may remove from the spent catalyst at least 90 wt %, at least 95 wt %, at least 99 wt %, or 100 wt % of the hydrocarbon feed. The carbon burning of a catalyst, such as a stripped spent catalyst, may remove from the spent catalyst at least 90 wt %, at least 95 wt %, at least 99 wt %, or 100 wt % of an aromatic product. An amount of soft coke may be absorbed and/or adsorbed to a catalyst, such as a spent catalyst, and the carbon burning of the catalyst may reduce the amount of soft coke absorbed and/or adsorbed to the spent catalyst. In some embodiments, the carbon burn step is conducted for a time period sufficient to reduce the wt % of carbon on a catalyst, such as a chlorinated spent catalyst, to less than any maximum weight percentage of carbon disclosed herein, for example, less than about 1 wt %, less than about 0.5 wt %, or less than about 0.2 wt %.

A carbon burning of a catalyst, such as a chlorinated catalyst, may improve the dispersion of the transition metal in the catalyst. For example, a carbon burning may improve the dispersion of a group VIII metal in the catalyst by at least 40%, at least 50%, at least 60%, at least 70%, at least 80%, or at least 90%.

### Partial Decoking Step

The methods provided herein may include a partial decoking step. The partial decoking step may be conducted at any effective point in a method, such as prior to a chlorination step. A partial decoking step may include contacting a catalyst, such as a spent catalyst, with a partial decoking gas stream, which may include oxygen.

The partial decoking gas stream may include any combination of an inert gas (one or more) and oxygen disclosed herein, for example, a mixture of nitrogen and oxygen, or air. The partial decoking gas stream may include a mole % of oxygen less than any maximum amount or in any range disclosed herein, for example, less than about 5 mole %, or in a range from about 0.1 to about 4 mole %, about 0.1 to about 3 mole %, from about 0.5 to about 3 mole %, or from about 1 to about 3 mole %.

A partial decoking gas stream may include any of the compounds disclosed herein, and any of the compounds disclosed herein may be excluded from a partial docking gas stream. For example, a partial decoking gas stream may be substantially free of halogen-containing compounds (e.g., substantially halogen-free). A partial decoking gas stream is “substantially free” of halogen-containing compounds when the halogen-containing compounds are present at a concentration of less than about 100 ppmw, less than about 50 ppmw, or less than about 25 ppmw. As a further example, the decoking gas stream may be substantially free of water. A decoking gas stream is “substantially free” of water when water is present at a concentration of less than about 100 ppmw, less than about 50 ppmw, or less than about 25 ppmw.

A partial decoking step may be conducted under any effective conditions (e.g., time, temperature, etc.). A partial decoking step may be conducted at a partial decoking temperature in any partial decoking temperature range disclosed herein, for example, from about 150° C. (about 302° F.) to about 600° C. (about 1,112° F.), from about 150° C. (about 302° F.) to about 250° C. (about 482° F.). A partial decoking step may be conducted for a time period in any range of partial de-coking time periods disclosed herein, for example, from about 1 hour to about 48 hours, or from about 2 to about 24 hours. A partial decoking step may be conducted for a time period sufficient to reduce the wt % of carbon on the spent catalyst to any range of weight percentage of carbon disclosed herein, for example, from about 0.05 wt % to about 10 wt %, from about 0.1 wt % to about 10 wt %, from about 0.05 wt % to about 5 wt %, from about 0.1 wt % to about 5 wt %, from about 1 wt % to 10 wt %, or from about 4 wt % to about 5 wt %.

### Pre-Drying Steps

The methods provided herein may include a pre-drying step. A pre-drying step may be performed any effective point in a process. In some embodiments, the methods include conducting a pre-drying step prior to a chlorination step.

A pre-drying step may include contacting a spent catalyst with a pre-drying gas stream. A pre-drying gas stream may include any inert gas disclosed herein, for example, nitrogen. A pre-drying gas stream may include any of the compounds disclosed herein, and any of the compounds disclosed herein may be excluded from a pre-drying gas. For example, a pre-drying gas stream may be substantially free of oxygen-containing compounds. A pre-drying gas stream is “substantially free” of oxygen-containing compounds when the oxygen-containing compounds are present at a concentration of less than about 100 ppmw, less than about 50 ppmw, or less than about 25 ppmw.

A pre-drying step may be performed under any effective conditions (e.g., time, temperature, pressure, etc.). A pre-drying step may be conducted at a pre-drying temperature in any pre-drying temperature range disclosed herein, for example, from about 75° C. to about 500° C., from about 100° C. to about 500° C., from about 0° C. to about 400° C., from about 100° C. to about 400° C., from about 125° C. to about 300° C., or from about 180° C. to about 280° C. A pre-drying step may be conducted for a time period in any range of pre-drying time periods disclosed herein, for example, from about 1 hour to about 96 hours, or from about 1 to about 48 hours. In some embodiments, a pre-drying step is conducted for a time period sufficient to reduce the moisture content of a catalyst, such as a spent catalyst, to a desirable extent, such as to a concentration less than any maximum moisture content of a spent catalyst disclosed herein, for example, less than about 4 wt %, or less than about 1 wt %.

### Chlorine Purging Step

The methods provided herein may include a chlorine purging step. A chlorine purging step may be performed at any point of the methods provided herein, such as prior to a carbon burn step.

A chlorine purging step may include contacting a catalyst, such as a chlorinated spent catalyst, with a chlorine purging stream. A chlorine purging stream may include any inert gas disclosed herein, for example, nitrogen. A chlorine purging stream may include any of the compounds disclosed herein, and any of the compounds disclosed herein may be excluded from a chlorine purging stream. For example, a chlorine purging stream may be substantially free of oxygen-containing compounds, for example, the oxygen-containing compounds are present at concentrations less than about 100 ppmw, less than about 50 ppmw, or less than about 25 ppmw. As a further example, a chlorine purging stream may be substantially free of halogen-containing compounds (substantially halogen-free), for example, the halogen-containing compounds are present at concentrations less than about 100 ppmw, less than about 50 ppmw, or less than about 25 ppmw.

A chlorine purging step may be performed under any effective conditions (e.g., time, temperature, pressure, etc.). In some embodiments, a chlorine purging step is conducted at a chlorine purging temperature in any chlorine purging temperature range disclosed herein, for example, from about 0° C. to about 400° C., from about 15° C. to about 350° C., from about 15° C. to about 300° C., or from about 25° C. to about 250° C. A chlorine purging step may be conducted for a time period in any range of chlorine purging time periods disclosed herein, for example, from about 1 hour to about 96 hours, from about 1 to about 48 hours. A chlorine purging step may be conducted for a time period sufficient to reduce the chlorine content of the outgoing chlorine purging effluent stream, after contacting a catalyst, such as a chlorinated spent catalyst, to less than any maximum chlorine content described herein, for example, less than about 100 ppmw, less than about 50 ppmw, or less than about 25 ppmw of chlorine-containing compounds.

### Fluorine Purging Step

The methods herein also may include a fluorine purging step. A fluorine purging step may be performed at any point in the methods herein, such as after a fluorination step. A fluorine purging step may include contacting a catalyst, such as a de-coked and fluorinated catalyst, with a fluorine purging stream. A fluorine purging stream may include any inert gas disclosed herein, for example, nitrogen.

A fluorine purging stream may include any of the compounds disclosed herein, and any of the compounds disclosed herein may be excluded from a fluorine purging stream. In some embodiments, a fluorine purging stream is substantially free of oxygen-containing compounds. A fluorine purging stream is “substantially free” of oxygen-containing compounds when oxygen-containing compounds are present at concentrations less than about 100 ppmw, less than about 50 ppmw, or less than about 25 ppmw. A fluorine purging stream may be substantially free of halogen-containing compounds (substantially halogen-free). A fluorine purging stream is “substantially free” of halogen-containing compounds when halogen-containing compounds are present at concentrations less than about 100 ppmw, less than about 50 ppmw, or less than about 25 ppmw.

A fluorine purging step may be performed under any effective conditions (e.g., time, temperature, pressure, etc.). In some embodiments, a fluorine purging step is conducted at a fluorine purging temperature in any fluorine purging temperature range disclosed herein, for example, from about 0° C. to about 500° C., from about 0° C. to about 400° C., from about 15° C. to about 475° C., from about 15° C. to about 300° C., or from about 25° C. to about 250° C., or from about 25° C. to about 450° C., such as about 450° C. A fluorine purging step may be conducted for a time period in any range of fluorine purging time periods disclosed herein, for example, from about 0.25 hours to about 72 hours, or from about 1 to about 48 hours. A fluorine purging step may be conducted for a time period sufficient to reduce the fluorine content of an outgoing fluorine purging effluent stream, after contacting the de-coked and fluorinated catalyst, to less than any maximum fluorine content described herein, for example, less than about 100 ppmw, less than about 50 ppmw, or less than about 25 ppmw of fluorine-containing compounds.

### Oxygen Purging Step

The methods provided herein may include an oxygen purging step. The oxygen purging step may be performed at any point of the methods provided herein, such as after a carbon burn step or a fluorine purge step.

An oxygen purging step may include contacting a catalyst with an oxygen purging stream. The oxygen purging stream may include any inert gas disclosed herein, for example, nitrogen. The oxygen purging stream may include any of the compounds disclosed herein, and any of the compounds disclosed herein may be excluded from the oxygen purging stream. An oxygen purging stream may be substantially free of oxygen-containing compounds, for example, oxygen-containing compounds may be present at concentrations less than about 100 ppmw, less than about 50 ppmw, or less than about 25 ppmw. The oxygen purging stream may be substantially free of halogen-containing compounds (substantially halogen-free), for example, the halogen-containing compounds may be present at concentrations less than about 100 ppmw, less than about 50 ppmw, or less than about 25 ppmw.

An oxygen purging step may be conducted under any effective conditions (e.g., time, temperature, pressure, etc.). For example, an oxygen purging step may be conducted at an oxygen purging temperature in any oxygen purging temperature range disclosed herein, for example, from about 0° C. to about 400° C., from about 15° C. to about 350° C., from about 25° C. to about 325° C., from about 25° C. to about 300° C., from about 15° C. to about 300° C., from about 25° C. to about 260° C., from about 25° C. to about 250° C., from about 0° C. to about 600° C., from about 15° C. to about 550° C., from about 25° C. to about 500° C., or from about 25° C. to about 450° C. An oxygen purging step may be conducted for a time period in any range of oxygen purging time periods disclosed herein, for example, from about 0.5 hours to about 96 hours, or from about 1 to about 48 hours. An oxygen purging step may be conducted for a time period sufficient to reduce the oxygen content of the outgoing oxygen purging effluent stream, after contacting the catalyst, to less than any maximum oxygen content described herein, for example, less than about 100 ppmw, less than about 50 ppmw, or less than about 25 ppmw of oxygen-containing compounds.

### Hydrocarbon Treatment Step

The methods provided herein may include a hydrocarbon treatment step. A hydrocarbon treatment step may be performed at any point in the methods herein, such as prior to a carbon burn step, the hydrocarbon treatment step comprising contacting the chlorinated spent catalyst with a hydrocarbon treatment stream that includes a hydrocarbon feed.

A hydrocarbon feed may include one or more alkanes and/or one or more cycloalkanes, such as C₆-C₈ alkanes and/or cycloalkanes.

A hydrocarbon treatment step may be performed under any effective conditions (e.g., time, temperature, pressure, etc.). In some embodiments, the hydrocarbon treatment step is conducted at a hydrocarbon treatment temperature in any hydrocarbon treatment temperature range disclosed herein, for example, from about 400° C. (about 752° F.) to about 600° C. (about 1,112° F.). A hydrocarbon treatment step may be conducted for a time period in any range of hydrocarbon treatment time periods disclosed herein, for example, from about 1 to about 48 hours.

### Reducing Step

The methods provided herein may include a reducing step. The reducing step may be performed at any point of the methods provided herein, such as after the fluorination step. A reducing step may include contacting a catalyst, such as a regenerated catalyst or the de-coked and fluorinated catalyst, with a reducing gas stream. The reducing gas stream may include molecular hydrogen. A reducing gas stream may include a mole % of molecular hydrogen greater than any minimum amount or in any range disclosed herein, for example, greater than about 25 mole %, or greater than about 75 mole %.

A reducing step may be performed under any effective conditions (e.g., time, temperature, pressure, etc.). The reducing of a catalyst, such as a regenerated catalyst, may occur at a temperature of about 600° F. to about 1,200° F., about 700° F. to about 1,100° F., about 800° F. to about 1,000° F., about 900° F. to about 1,000° F., or about 950° F. to about 1,000° F. The reducing of a catalyst, such as a regenerated catalyst, may occur, at least partially, in an atmosphere that includes an inert gas (such as nitrogen), hydrogen (H₂), or a combination thereof. A reducing step may be conducted at a peak reducing temperature in any peak reducing temperature range disclosed herein, for example, from about 200° C. to about 600° C., or from about 400° C. to about 600° C. A reducing step may be started at an initial reducing temperature which is the same as any oxygen purge temperature disclosed herein, for example, in a range from about 0° C. to about 600° C., from about 15° C. to about 550° C., from about 25° C. to about 500° C., from about 25° C. to about 450° C., from about 0° C. to about 500° C., from about 0° C. to about 300° C., from about 20° C. to about 250° C., or from about 15° C. to about 50° C. A reducing step may be conducted for a time period in any range of reducing step time periods disclosed herein, for example, from about 0.5 hours to about 48 hours, from about 10 to about 30 hours.

### Catalysts

The catalysts subjected to the methods provided herein may include any known catalysts, which may include any known catalyst support. A catalyst support may include a zeolite, an amorphous inorganic oxide, or any combination thereof.

A catalyst support may include an L-zeolite, a Y-zeolite, a mordenite, an omega zeolite, and/or a beta zeolite. A catalyst support may include a potassium L-zeolite or a barium ion-exchanged L-zeolite.

The catalysts may include a binder, such as a binder that includes alumina, silica, a mixed oxide thereof, or a mixture thereof.

The catalysts may include a metal, such as a transition metal. The transition metal may include a Group 8-11 transition metal. The transition metal may include platinum. A catalyst may include any weight percentage range of a transition metal; for example, from about 0.1 wt % to about 10 wt %, or from about 0.3 wt % to about 5 wt %, of a transition metal.

A spent catalyst may include any weight percentage range of a transition metal, such as platinum. For example, a spent catalyst may include a transition metal at any amount of from about 0.1 wt % to about 10 wt %, or from about 0.5 wt % to about 2 wt %, platinum.

In some embodiments, a catalyst includes platinum on a KL-zeolite. The catalyst may also include chlorine and fluorine. For example, a catalyst may include any weight percentage range of chlorine and/or weight percentage range of fluorine disclosed herein, for example, from about 0.01 wt % to about 5 wt %, or from about 0.3 to about 1.3 wt % fluorine, and/or from about 0.01 wt % to about 5 wt %, from about 0.3 to about 3 wt %, or from about 0.3 to about 1.3 wt % chlorine. When chlorine and fluorine are present, the chlorine and fluorine may be present at any ratio. For example, a catalyst may include a molar ratio of chlorine:fluorine of from about 0.5:1 to about 4:1.

### Regenerated/Reactivated Catalysts

Also provided herein are catalysts that have been subjected to a method provided herein, such as reactivated catalysts or regenerated catalysts produced by the method herein. In some embodiments, the reactivated catalysts or regenerated catalysts include any amount of iron disclosed herein, for example, less than about 400 ppmw, less than about 300 ppmw, less than about 250 ppmw, from about 5 ppmw to about 400 ppmw, from about 50 ppmw to about 300 ppmw, or from about 50 ppmw to about 250 ppmw iron. In some embodiments, the reactivated catalysts or regenerated catalysts include any amount of iron disclosed herein, for example, the difference in iron concentration between the reactivated catalyst and the spent catalyst is less than about 1,000 ppmw, less than about 600 ppmw, less than about 400 ppmw, from about 5 ppmw to about 600 ppmw, from about 5 ppmw to about 500 ppmw, or from about 5 ppmw to about 300 ppmw iron.

In some embodiments, the reactivated catalysts or regenerated catalysts include any amount of carbon disclosed herein, for example, less than about 1 wt %, less than about 0.5 wt %, from about 0.01 wt % to about 1 wt %, from about 0.01 wt % to about 0.75 wt %, from about 0.01 wt % to about 0.5 wt %, or from about 0.02 wt % to about 0.5 wt % carbon.

In some embodiments, the reactivated catalysts or regenerated catalysts include any amount of chlorine disclosed herein, for example, from about 0.01 wt % to about 5 wt %, from about 0.05 wt % to about 3 wt %, from about 0.05 wt % to about 2.0 wt %, from about 0.3 wt % to about 1.3 wt % chlorine.

In some embodiments, the reactivated catalysts or regenerated catalysts include any amount of fluorine disclosed herein, for example, from about 0.01 wt % to about 5 wt %, from about 0.05 wt % to about 3 wt %, from about 0.01 wt % to about 3 wt %, from about 0.1 wt % to about 1.3 wt %, or from about 0.15 wt % to about 1.3 wt % fluorine.

In some embodiments, the reactivated catalysts or regenerated catalysts include any amount of fluorine disclosed herein, for example, from about 0.01 wt % to about 5 wt %, from about 0.05 wt % to about 3 wt %, from about 0.01 wt % to about 3 wt %, from about 0.1 wt % to about 1.3 wt %, or from about 0.15 wt % to about 1.3 wt % fluorine.

In some embodiments, the reactivated catalysts or regenerated catalysts are characterized by a TEOR within about 50° F., within about 40° F., within about 30° F., or within about 20° F., of the TEOR of a fresh reference catalyst. A reactivated catalyst or regenerated catalyst may be characterized by a TSOR within about 50° F., within about 40° F., within about 30° F., or within about 20° F., of the TSOR of a fresh reference catalyst. A reactivated catalyst or regenerated catalyst may be characterized by a fouling rate (FR) in any range disclosed herein, for example, from about 0.01° F./hr to about 0.25° F./hr, from about 0.02° F./hr to about 0.2° F./hr, from about 0.03° F./hr to about 0.2° F./hr, or from about 0.03° F./hr to about 0.15° F./hr. A reactivated catalyst or regenerated catalyst may be characterized by a benzene+toluene selectivity in any selectivity range disclosed herein, for example, from about 0.88 to about 0.95, or from about 0.89 to about 0.94. A reactivated catalyst or regenerated catalyst may be characterized by a benzene+toluene selectivity in any selectivity range disclosed herein, for example, from about greater that 0.88, or greater than 0.90.

The methods provided herein also include methods of using a reactivated and/or regenerated catalyst. In some embodiments, the methods include providing a catalyst that has been subjected to any one or more of the regenerating/reactivating methods provided herein, and contacting the catalyst and a reactant, such as a hydrocarbon, to produce a product, such as an aromatic product.

### EXAMPLES

The disclosure is further illustrated by the following examples, which are not to be construed in any way as imposing limitations to the scope of this technology. Various other aspects, embodiments, modifications, and equivalents thereof which, after reading the description herein, can suggest themselves to one of ordinary skill in the art without departing from the spirit of the present disclosure or the scope of the appended claims.

Weight percentages of Pt, Cl, F, and Fe were determined using X-ray fluorescence (XRF), and are based on the total weight of the aromatization catalyst, unless stated otherwise. Carbon (wt %) was determined by CHNS analyzer (Carlo Erba). Platinum dispersions were determined by CO pulse chemisorption.

Regenerated catalysts in some of the examples that follow were tested for their respective fouling rates (abbreviated FR, units of ° F./hr), which correlate to their activities by the formula, y=FR*t+TSOR, where y is temperature, FR is the fouling rate, t is time, and TSOR is the initial start of run temperature. The FR of a regenerated catalyst sample was determined by plotting the temperature required to maintain a total aromatics yield at 75 wt % over time at standard test conditions, as described later herein. The FR's were then determined from the calculated slopes fit to the resulting data. The total time on stream was typically 40 hr, and the end of run temperature (abbreviated TEOR) also was determined.

In each of the examples, the following standard testing procedures were utilized. The catalysts were ground and sieved to about 20-40 mesh, and 2 cc of the sieved catalyst was placed in a ¼-inch OD stainless steel reactor vessel in a temperature-controlled furnace. After reducing the catalyst under flowing molecular hydrogen, a feed stream of aliphatic hydrocarbons (about 12 mL/hour) and molecular hydrogen (about 65 mL/min) was introduced to the reactor vessel, a pressure of about 65 psig, a H₂:hydrocarbon molar ratio of 2.0:1, and a liquid hourly space velocity (LHSV) of 6 hr⁻¹ to obtain catalyst performance data over time. The aliphatic hydrocarbon feed contained from about 22 to 32 wt % n-hexane, about 4 to 8 wt % n-heptane, about 33 to 37 wt % C₆ iso-paraffins, about 15 to 21 wt % C₇ iso-paraffins, and about 6 to 10 wt % C₈ iso-paraffins, with the balance attributable to C₆ and C₇ olefins, naphthenes, and aromatics. The reactor effluent composition was analyzed by gas chromatography to determine the total aromatics and the benzene+toluene selectivity.

In the examples, experiments were conducted to demonstrate the effectiveness of various processes and steps in regenerating a spent catalyst, with the performance of a fresh aromatization catalyst used as a target baseline. The fresh aromatization catalyst was a Pt/KL-zeolite containing approximately 1 wt % platinum, 0.85 wt % Cl, and 0.70 wt % F, with a BET surface area of approximately 177.5 m²/g, a mercury intruded pore volume of about 0.19 cc/g, and a micropore volume of about 0.0615 cc/g. The source of the spent catalyst was the fresh catalyst, but after it had been deactivated after long-term use in an aromatization process. Prior to usage in these examples, the spent catalyst was subjected to a mild partial decoking treatment to remove unreacted hydrocarbons and light carbonaceous deposits from the catalyst.

### Example 1A—Preparation of a Regenerated Catalyst with Fluorine

For comparison purposes, the following regeneration procedure, which included the use of fluorine gas, was conducted. Approximately 42 g of the spent catalyst was charged to a new metal fixed-bed reactor (comprising 347 stainless steel), unless noted otherwise, then contacted at about 400° F. (about 204.4° C.) with a nitrogen gas stream (about 1500 mL/min) for 12 hr, then contacted at about 300° F. (about 148.9° C.) with a chlorine-containing gas stream containing nitrogen (about 1463 mL/min) and chlorine gas (e.g., a blend of 2% Cl₂ in N₂) (about 37 mL/min) for approximately 3 hr, then contacted at about 400° F. (about 204.4° C.) with a nitrogen gas stream (1463 mL/min or 1500 mL/min) for approximately 3 hours, or about 12 hours to about 16 hours, then contacted at about 850° F. (about 454.4° C.) with a decoking gas stream containing a mixture of air (75 mL/min) and nitrogen (1425 mL/min) for approximately 44 hr, then contacted at about 300° F. (about 148.9° C.) with a fluorine-containing gas stream containing nitrogen (about 1350 mL/min) and fluorine gas (e.g., a blend of F₂ gas in N₂) (about 147 mL/min) for approximately 3 hr, and then contacted at about 400° F. (about 204.4° C.) with a nitrogen gas stream (about 1353 mL/min or about 1500 mL/min) for approximately 3 hours, or about 12 hours to about 16 hours.

### Example 1B—Preparation of a Regenerated Catalyst with a Hydrofluorocarbon in Two Reactors

An amount of the spent catalyst was charged to a new metal fixed-bed reactor (comprising stainless steel 347), unless noted otherwise (for example, in some tests, fluorine gas was in a container comprising stainless steel 347, and a hydrofluorocarbon was in a container comprising stainless steel 321). The spent catalyst was then contacted at about 400° F. (about 204.4° C.) with a nitrogen gas stream (about 1500 mL/min) for approximately 12 hr, then contacted at about 300° F. (about 148.9° C.) with a chlorine-containing gas stream containing nitrogen (about 1463 mL/min) and chlorine gas (e.g., 2% Cl₂ in N₂) (about 37 mL/min) for approximately 3 hr, then contacted at about 400° F. (about 204.4° C.) with a nitrogen gas stream (about 1463 mL/min) for approximately 3 hours, or about 12 hours to about 16 hours, then contacted at about 850° F. (about 454.4° C.) with a de-coking gas stream containing air (about 500 mL/min) for approximately 2 hours to produce a de-coked catalyst. The temperature was reduced to 700° F. and the air flow was reduced to 200 mL/min. This was repeated several times to make a large batch of chlorided decoked catalyst.

About 45 g of the chloride de-coked catalyst was transferred to a reactor (stainless steel 347) having an outer diameter of one inch. A stream of 1,1,1,2-tetrafluoroethane (20%) in N₂ having a flow rate of about 17 mL/min was combined with the second stream of 200 mL/min air—to produce a combined stream. The de-coked catalyst was contacted with the combined stream at 50 psi pressure for about 60 minutes. At the end of the 60 minute contact time the FREON™ fluorinated organic compound/N₂ flow was stopped. A purge continued for 30 minutes with 200 mL/min air at 730° F. and 50 psi. The temperature was reduced to 500° F., once below 500° F. the air was stopped and 200 mL/min N₂ was started. The catalyst was cooled to room temperature in the N₂ flow.

### Example 1C—Preparation of a Regenerated Catalyst with a Hydrofluorocarbon in One Reactor

Approximately 60 g of the spent catalyst was charged to a new metal fixed-bed reactor (comprising 321 stainless steel), unless noted otherwise, then contacted at about 400° F. (about 204.4° C.) with a nitrogen gas stream (about 1700 mL/min) for 12 hr, then contacted at about 300° F. (about 148.9° C.) with a chlorine-containing gas stream containing nitrogen (about 1640 mL/min) and chlorine gas (e.g., a blend of 2% Cl₂ in N₂) (about 40 mL/min) for approximately 3 hr, then contacted at about 400° F. (about 204.4° C.) with a nitrogen gas stream (about 1640 mL/min) for approximately 3 hours, or about 12 hours to about 16 hours, then contacted at about 850° F. (about 454.4° C.) with a decoking gas stream of air (680 mL/min) for approximately 2 hr.

The air flow was reduced (about 280 mL/min) and a stream of 1,1,1,2-tetrafluoroethane (20%) in N₂ having a flow rate of about 22 mL/min was combined with the air to produce a combined stream. The de-coked catalyst was contacted with the combined stream at 50 psi pressure for about 60 minutes. At the end of the 60 minute contact time the FREON™ fluorinated organic compound/N₂ flow was stopped. A purge continued for 30 minutes with 200 mL/min air at 730° F. and 50 psi. The temperature was reduced to 500° F., once below 500° F. the air was stopped and the catalyst was cooled to room temperature in a N₂ flow (about 500 mL/min).

### Example 1D—Preparation of a Regenerated Catalyst with a Hydrofluorocarbon in One Reactor

Approximately 30 g of the spent catalyst was charged to a new metal fixed-bed reactor (comprising 321 stainless steel), unless noted otherwise, then contacted at about 400° F. (about 204.4° C.) with a nitrogen gas stream (about 2363 mL/min) for 12 hr, then contacted at about 400° F. (about 148.9° C.) with a chlorine-containing gas stream containing nitrogen (about 2333 mL/min) and chlorine gas (e.g., a blend of 2% Cl₂ in N₂) (about 30 mL/min) for approximately 3 hr, then contacted at about 400° F. (about 204.4° C.) with a nitrogen gas stream (about 2333 mL/min) for approximately 3 hours, or about 12 hours to about 16 hours, then contacted at about 400° F. (about 204.4° C.) with a decoking gas stream of air (112 mL/min) and nitrogen (2258 mL/min) for approximately 30 min, then contacted at about 850° F. (about 454.4° C.) with a decoking gas stream of air (336 mL/min) and nitrogen flow (2025 mL/min) for approximately 3 hours.

The air flow continued (about 336 mL/min), the nitrogen flow was reduced (about 2000 mL/min), and a stream of 1,1,1,2-tetrafluoroethane (5%) in N₂ having a flow rate of about 25 mL/min was combined with the air to produce a combined stream. The de-coked catalyst was contacted with the combined stream at 50 psi pressure for about 60 minutes. At the end of the 60 minute contact time the FREON™ fluorinated organic compound/N₂ flow was stopped. A purge continued for 30 minutes with the air (about 336 mL/min) and nitrogen (about 2,000 mL/min) streams at 700° F. and 50 psi. The temperature was reduced to 500° F., once below 500° F. the air was stopped and the catalyst was cooled to room temperature in the N₂ flow.

The resulting regenerated catalysts were then tested to determine its fluorine concentration. Two samples of the regenerated catalysts were collected from the vertically-oriented reactor for testing: a first sample from the “top” half of the reactor, and a second sample from the “bottom” half of the reactor. The results of these tests are depicted in the following table.

wt % F (XRF)

| | Before | | After Regeneration | | |
|---|---|---|---|---|---|
| Sample | Regeneration | 1A | 1B | 1C | 1D |
| “Top” Half | 0-0.10 | 1.2 | 0.56 | 0.645 | 0.314 |
| of Reactor | | | | | |
| “Bottom” | 0-0.10 | 0.1 | 0.38 | 0.216 | 0.297 |
| Half of | | | | | |
| Reactor | | | | | |

The results of this table indicated that the 1,1,1,2-tetrafluoroethane achieved an improved distribution of fluorine in the regenerated catalyst. Although the 1,1,1,2-tetrafluoroethane achieved a better distribution in example 1B than fluorine gas, it should be noted that the foregoing treatment with 1,1,1,2-tetrafluoroethane was performed on a spent catalyst that had been treated with the foregoing chlorine-containing gas stream and a de-coking gas stream, and then transferred to a different reactor for the treatment with 1,1,1,2-tetrafluoroethane. The transfer between reactors may have subjected the catalyst to moisture, which may have improved the fluorine distribution. If this possible moisture exposure were avoided (e.g., by performing each of the three above-described steps in a single reactor), then the fluorine distribution may not match the foregoing results, but, in all likelihood, would still exceed the results achieved with fluorine gas to a surprising extent. The same trend in fluorine distribution was also observed in Examples 1C and 1D. The reactivation process in those examples were performed in one reactor therefore there was no possibility of exposure to moisture

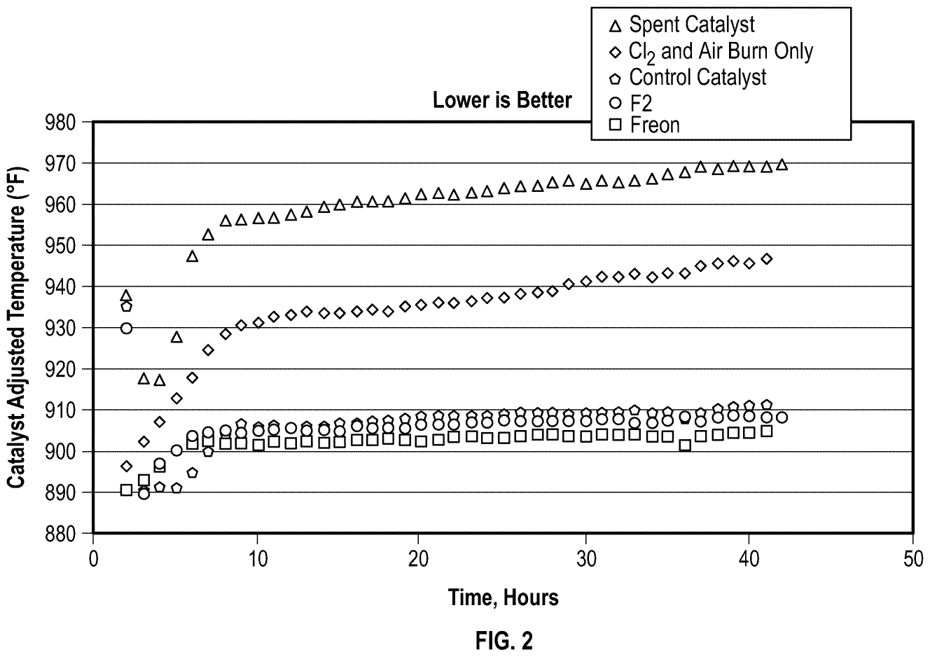

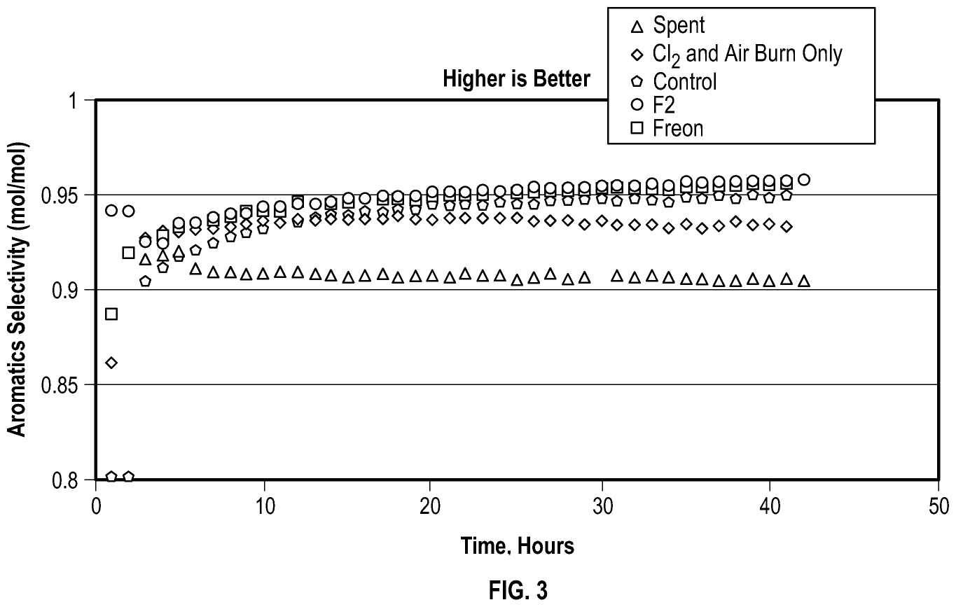

A series of aromatization reactions was then run to test and compare the catalyst adjusted temperature and selectivity of the reactivated catalysts: FIG. 2 depicts a plot of the catalyst adjusted temperature versus time, and FIG. 3 depicts a plot of aromatics selectivity versus time for (1) a fresh aromatization catalyst, (2) a spent aromatization catalyst, (3) a spent aromatization catalyst treated with Cl₂ and O₂ for 8 hours according to the foregoing procedure, (4) a spent aromatization catalyst treated with Cl₂, O₂, and fluorine gas according to Example 1A, and (5) a spent aromatization catalyst subjected to the reactivation procedure of Example 1B, which included treating the catalyst with 1,1,1,2-tetrafluoroethane.

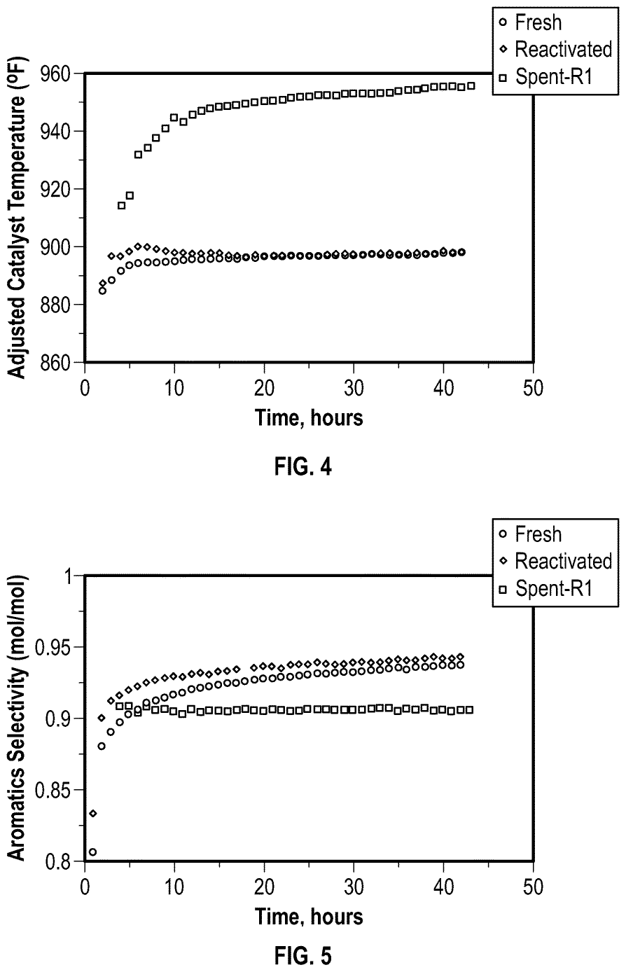

FIG. 4 depicts a plot of the catalyst adjusted temperature versus time and FIG. 5 depicts a plot of aromatics selectivity versus time for (1) an embodiment of a fresh aromatization catalyst, (2) an embodiment of a spent aromatization catalyst, and (3) a spent aromatization catalyst subjected to the reactivation procedure of Example 1C, which included treating the catalyst with 1,1,1,2-tetrafluoroethane.

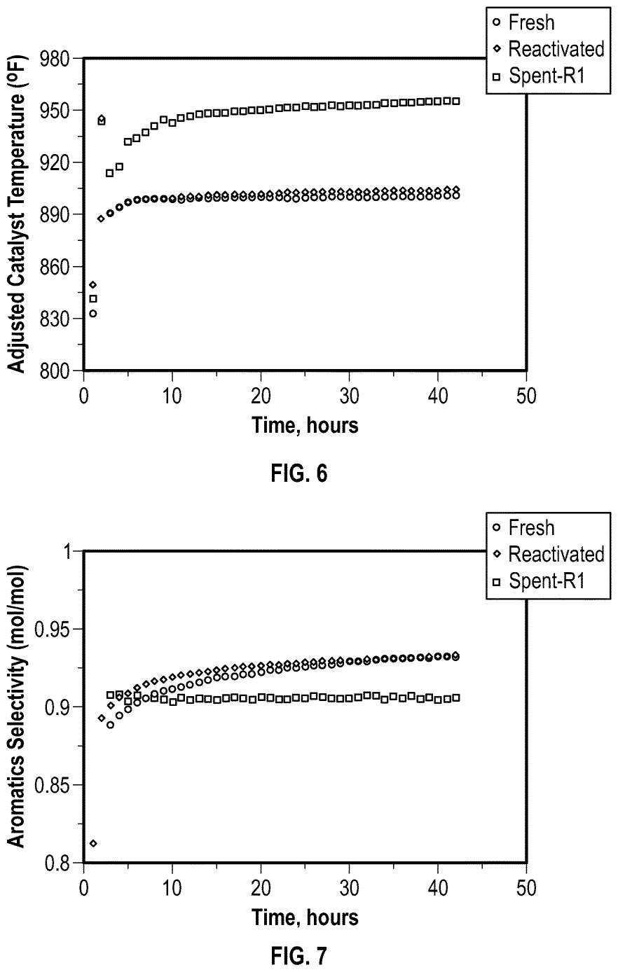

FIG. 6 depicts a plot of the catalyst adjusted temperature versus time, and FIG. 7 depicts a plot of aromatics selectivity versus time for (1) an embodiment of a fresh aromatization catalyst, (2) an embodiment of a spent aromatization catalyst, and (3) a spent aromatization catalyst subjected to the reactivation procedure of Example 1D, which included treating the catalyst with 1,1,1,2-tetrafluoroethane.

The data of FIG. 2-FIG. 7 demonstrated that an activity substantially equivalent to the activity of the fresh catalyst could be restored using fluorine gas or FREON™ fluorinated organic compound as the fluoride source.

### Example 2—Preparation of a Regenerated Catalyst with a Hydrofluorocarbon with a Down Stream Reactor

FREON™ fluorinated organic compound may be used as a fluoriding agent. When FREON™ fluorinated organic compound is used, a temperature at which a spent catalyst is contacted with the FREON™ fluorinated organic compound may be between 700 OF to 850° F. in order to decompose the FREON™ fluorinated organic compound, thereby allowing fluorine to deposit on the spent catalyst.

Laboratory scale testing included fluoriding with one pass over a spent catalyst with FREON™ fluorinated organic compound in nitrogen, with up to 3% oxygen. When one pass was used, it was observed that a temperature of at least 850° F. was needed to decompose a desired portion of the FREON™ fluorinated organic compound in order deposit fluorine on the catalyst.

The distribution of the fluorine through the catalyst bed, however, was generally poor in these laboratory scale tests, and there were concerns regarding the furnace/reactor metallurgy.

Therefore, lower decomposition temperatures were tested. At the lower decomposition temperatures one pass resulted in the decomposition of only a small portion of the FREON™ fluorinated organic compound, but the fluorine distribution through the catalyst bed was improved. Lower temperatures, therefore, were advantageous in some ways.

If this procedure were performed in commercial units in which all furnaces/reactors were maintained at decomposition temperatures then only a portion of the FREON™ fluorinated organic compound would decompose and then contact with each subsequent catalyst bed would deposit a similar portion of the Freon in the feed (now lower than the previous bed), which was believed to cause an uneven loading and possibly other problems. There were also concerns that decomposition of FREON™ fluorinated organic compound in a furnace could produce hydrogen fluoride, and potentially damage the metal of the furnace or other component of a system. Therefore keeping the targeted reactor at an appropriate temperature to decompose the Freon while keeping the remainder of the plant below the FREON™ fluorinated organic compound decomposition temperature and recycling the reactor effluent back to the targeted reactor would ensure the proper fluorine loading on the catalyst. To show the Freon or decomposition products in the effluent of the targeted reactor would not affect the downstream metallurgy the following test was performed, the results of one of these tests are provided in the following table. In the test, a fluorine-containing stream (which included FREON™ fluorinated organic compound) was circulated sequentially through Reactor 1, a furnace tube, and Reactor 2. Reactor 1 and Reactor 2 contained spent catalyst that had previously been dried, chloride, purged, and oxidized as described in Example 1D. The furnace tube was filled with support balls, which were added to assist with heat transfer.

### Results of Example 2 (Single Pass)

| Result/Setting | Reactor 1 | | Furnace Tube | Reactor 2 | |
|---|---|---|---|---|---|
| Temperature | 730° | F. | 700° F. | 600° | F. |
| Wt % of FREON ™ | 20 | wt % | — | — | |
| fluorinated organic | | | | | |
| compound that | | | | | |
| decomposed | | | | | |
| Wt % of fluorine | 0.295 | wt % | — | 0.06 | wt% |
| present on catalyst | | | | | |

To alleviate one or more of these concerns, fluorination was performed by keeping only one furnace/reactor at a decomposition temperature, i.e., a fluorination temperature. By keeping the temperature of the other furnaces/reactors at temperatures below the decomposition temperature, the decomposition of FREON™ fluorinated organic compound was reduced or minimized in the furnaces/reactors at the lower temperatures, and, as a result, a significant portion of the FREON™ fluorinated organic compound, if any, would not deposit in those reactors.

### Example 3—Preparation of a Regenerated Catalyst with a Hydrofluorocarbon with Recycle

Approximately 61 g of the spent catalyst was charged to a metal fixed-bed reactor (comprising 321 stainless steel), unless noted otherwise, then contacted at about 400° F. (about 204.4° C.) with a nitrogen gas stream (about 9291 mL/min) for about 12 hr, then contacted at about 400° F. (about 148.9° C.) with a chlorine-containing gas stream containing nitrogen (about 9236 mL/min) and chlorine gas (e.g., a blend of 2% Cl₂ in N₂) (about 55 mL/min) for approximately 3 hr, then contacted at about 400° F. (about 204.4° C.) with a nitrogen gas stream (about 9236 mL/min) for approximately 3 hours, or about 12 hours to about 16 hours, then contacted at about 400° F. (about 204.4° C.) with a decoking gas stream of air (444 mL/min) and nitrogen (8847 mL/min) for approximately 30 min, then contacted at about 850° F. (about 454.4° C.) with a decoking gas stream of air (1325 mL/min) and nitrogen flow (7966 mL/min) for approximately 3 hours.

The air flow (about 258 mL/min) and nitrogen flow continued (about 1522 mL/min), was fed to the reactor. While the mixture of air and nitrogen was flowing to the reactor, the compressor was set to deliver 1800 sccm of total flow back to the reactor. The recycle flow was checked using a flow measurement system installed on the recycle loop (or, in other words, “feedback loop”, such as the “feedback loop” 102 depicted at FIG. 1). Once the recycle flow rate was confirmed, the mixture of air and nitrogen feed was stopped while simultaneously blocking in the reactor system with the recycle loop. This allowed to operate the system in 100% recycle mode without flowing fresh gas into the reactor and while maintaining reactor pressure at 50 psig. The recycle loop was run for 10 minutes then a stream of 1,1,1,2-tetrafluoroethane (5%) in N₂ having a flow rate of 20 mL/min was combined with the recycle stream at the inlet of the reactor to produce a combined stream. The de-coked catalyst was contacted with the combined stream at 730° F. at 50 psig pressure. After 10 minutes collected a gas bag sample of the reactor effluent as shown in FIG. 1. At 60 minutes the FREON™ fluorinated organic compound flow was stopped and the compressor continued running in the recycle loop for 120 minutes. A second sample bag was taken at 180 minutes. The compressor was stopped and the reactor was purged with a combined air (about 286 mL/min) and nitrogen (about 1714 mL/min) streams at 730° F. and 50 psi for 30 minutes. The reactor was cooled to room temperature in the flow of Air and nitrogen.

### Results of Example 3

| | Time after starting the | % Freon |
|---|---|---|
| | introduction of Freon | from initial |
| Sample | into the reactor (min) | concentration |
| Feed | — | 100 |
| Gas bag 1 | 10 | 51 |
| Gas bag 2 | 180 | 1.1 |

During the reactivation the FREON™ fluorinated organic compound was then transported around a recycle loop back to the targeted furnace/reactor, i.e., the furnace/reactor kept at a decomposition temperature. This procedure sometimes required multiple passes of the FREON™ fluorinated organic compound through the recycle loop, but it is believed that this procedure maximizes the amount of fluorine that contacts and is placed on the targeted reactor, i.e., the reactor kept at a decomposition temperature.

### ASPECTS

The following is a listing of non-limiting aspects:

Aspect 1. A reforming method comprising, consisting essentially of, or

consisting of any two or more of the following steps:
(A) contacting a hydrocarbon feed with an aromatization catalyst comprising a transition metal and a catalyst support under reforming conditions in a metal reactor system to produce an aromatic product;
(B) performing step (A) for a time period sufficient to form a spent catalyst;
(C) contacting the spent catalyst with hydrogen gas to produce a stripped spent catalyst;
(D) subjecting the stripped spent catalyst to a carbon burn at a temperature, such as a temperature not exceeding about 500° F., for a time effective to remove from the spent catalyst at least a portion of the hydrogen carbon feed, at least a portion of the aromatic product, or a combination thereof to form a treated spent catalyst;
(E) contacting the treated spent catalyst with a chlorine-containing stream comprising a chlorine-containing compound to produce a chlorinated spent catalyst;
(F) subjecting the chlorinated spent catalyst to a carbon burn at a temperature, such as a temperature not exceeding 900° F., for a time effective to improve a dispersion of the transition metal in the chlorinated spent catalyst to form a redistributed spent catalyst; and
(G) contacting the redistributed spent catalyst with a fluorine-containing stream comprising a fluorine-containing compound to form a regenerated catalyst; and
(H) reducing the regenerated catalyst.

Aspect 2. The method defined in aspect 1, wherein the reforming method is an in situ process, for example, steps (A)-(H) are performed in the same reactor system.

Aspect 3. The method defined in aspect 1, wherein steps (C)-(H) are performed externally to the reactor system of steps (A)-(B), for example, steps (C)-(H) are performed in a metal reactor that is not in the reforming reactor system.

Aspect 4. The method defined in any of aspects 1-3, further comprising a step of reactivating the catalyst after step (H).

Aspect 5. A method of regenerating a spent catalyst comprising a transition metal and a catalyst support in a metal reactor, the method comprising, consisting essentially of, or consisting of any two or more of the following steps:
(1) contacting the spent catalyst with hydrogen gas to produce a stripped spent catalyst;
(2) subjecting the stripped spent catalyst to a carbon burn at a temperature, such as a temperature not exceeding about 500° F., for a time effective to remove from the spent catalyst at least a portion of the hydrogen carbon feed, at least a portion of the aromatic product, or a combination thereof to form a treated spent catalyst:
(3) contacting the treated spent catalyst with a chlorine-containing stream comprising a chlorine-containing compound to produce a chlorinated spent catalyst;
(4) subjecting the chlorinated spent catalyst to a carbon burn at a temperature, such as a temperature not exceeding 900° F., for a time effective to improve a dispersion of the transition metal in the chlorinated spent catalyst to form a redistributed spent catalyst;
(5) contacting the redistributed spent catalyst with a fluorine-containing stream comprising a fluorine-containing compound to form a regenerated catalyst; and
(6) reducing the regenerated catalyst.

Aspect 6. A reforming method comprising, consisting essentially of, or consisting of any two or more of the following steps:
(A) contacting a hydrocarbon feed with an aromatization catalyst comprising a transition metal and a catalyst support under reforming conditions in a metal reactor system to produce an aromatic product;
(B) performing step (A) for a time period sufficient to form a spent catalyst;
(C) contacting the spent catalyst with a chlorine-containing stream comprising a chlorine-containing compound to produce a chlorinated spent catalyst, wherein, optionally, the chlorine-containing compound comprises chlorine, a chlorinated hydrocarbon, a chlorofluorocarbon (CFC), a hydrochlorofluorocarbon (HCFC), or a combination thereof;
(D) contacting the chlorinated spent catalyst with a decoking gas stream comprising oxygen to produce a de-coked catalyst; and
(E) contacting the de-coked catalyst with a fluorine-containing stream comprising a fluorine-containing compound, wherein the fluorine-containing compound comprises a hydrofluorocarbon (HFC), a chlorofluorocarbon (CFC), a hydrochlorofluorocarbon (HCFC), a fluorocarbon (FC), or a combination thereof.

Aspect 7. The method defined in aspect 6, wherein the reforming method is an in situ process, for example, steps (A)-(E) are performed in the same reactor system.

Aspect 8. The method defined in aspect 6, wherein steps (C)-(E) are performed externally to the reactor system of steps (A)-(B), for example, steps (C)-(E) are performed in a metal reactor that is not in the reforming reactor system.

Aspect 9. The method defined in any of aspects 6-8, further comprising a step of reactivating the catalyst after step (E).

Aspect 10. A method of regenerating a spent catalyst comprising a transition metal and a catalyst support in a metal reactor, the method comprising, consisting essentially of, or consisting of:
(1) contacting the spent catalyst with a chlorine-containing stream comprising a chlorine-containing compound to produce a chlorinated spent catalyst;
(2) contacting the chlorinated spent catalyst with a decoking gas stream comprising oxygen to produce a de-coked catalyst; and
(3) contacting the de-coked catalyst with a fluorine-containing stream comprising a fluorine-containing compound to produce a regenerated catalyst, wherein the fluorine-containing compound comprises a hydrofluorocarbon (HFC), a chlorofluorocarbon (CFC), a hydrochlorofluorocarbon (HCFC), a fluorocarbon (FC), or a combination thereof.

Aspect 11. The method defined in any of the preceding aspects, wherein the contacting of the spent catalyst with hydrogen gas occurs, at least in part, at a temperature greater than 25° F., greater than 100° F., greater than 200° F., greater than 300° F., greater than 400° F., or greater than 500° F.

Aspect 12. The method defined in any of the preceding aspects, wherein the contacting of the spent catalyst with hydrogen gas occurs, at least in part, at a temperature of about 300° F. to about 800° F., about 400° F. to about 800° F., or about 500° F. to about 800° F.

Aspect 13. The method defined in any of the preceding aspects, wherein the contacting of the spent catalyst with hydrogen gas occurs for a time of about 1 minute to about 24 hours, about 1 minute to about 18 hours, about 1 minute to about 12 hours, about 1 minute to about 6 hours, or about 1 minute to about 2 hours.

Aspect 14. The method defined in any of the preceding aspects, wherein the fluorine-containing compound comprises, consists essentially of, or consists of a hydrofluorocarbon (HFC), a chlorofluorocarbon (CFC), a hydrochlorofluorocarbon (HCFC), a fluorocarbon (FC), or a combination thereof.

Aspect 15. The method defined in any of the preceding aspects, wherein the fluorine-containing stream comprises (or consists essentially of, or consists of) (i) the fluorine-containing compound and any inert gas disclosed herein, for example, nitrogen, (ii) the fluorine-containing compound, any inert gas disclosed herein, and air, (iii) the fluorine-containing compound and air, or (iv) the fluorine-containing compound, oxygen (O₂), and any inert gas disclosed herein, for example, nitrogen; wherein when the fluorine-containing stream includes an inert gas and air, the inert gas and air may be present at a volume ratio of about 3:1 to about 30:1, about 3:1 to about 20:1, about 3:1 to about 10:1, about 3:1 to about 5:1, or about 4:1; or the volume ratio of the inert gas to oxygen (O₂) in the fluorine-containing stream is about 90:10 to about 99.9:0.1, about 95:5 to about 99:1, or about 97:3 (inert gas:oxygen (O₂)).

Aspect 16. The method defined in any of the preceding aspects, wherein the contacting of the redistributed spent catalyst with a fluorine-containing stream comprises (consists essentially of, or consists of) circulating the inert gas, and injecting the fluorine-containing compound into the circulating inert gas.

Aspect 17. The method defined in any of the preceding aspects, wherein the injecting of the fluorine-containing compound is achieved, at least in part, with a spraying apparatus configured to disperse the fluorine-containing compound in the circulating inert gas.

Aspect 18. The method defined in any of the preceding aspects, wherein the contacting of the redistributed spent catalyst with a fluorine-containing stream comprises (consists essentially of, or consisting of) circulating a stream comprising the inert gas and oxygen (O₂), and injecting the fluorine-containing compound into the circulating stream.

Aspect 19. The method defined in any of the preceding aspects, wherein the oxygen (O₂) is present in the circulating stream at a concentration of about 0.01% to about 10%, about 0.01% to about 8%, about 0.01% to about 6%, about 0.01% to about 4%, about 1% to about 4%, about 2% to about 4%, about 2.5% to about 3.5%, or about 3%, by volume.

Aspect 20. The method defined in any of the preceding aspects, wherein (i) an amount of fluorine-containing compound in the fluorine-containing stream, (ii) a duration of the contacting of the spent catalyst with the fluorine-containing stream, or (iii) a combination thereof is selected to place on the redistributed spent catalyst about 0.1 wt % to about 2 wt %, about 0.5 wt % to about 1.5 wt %, about 0.5 wt % to about 1 wt %, or about 0.8 wt % to about 1 wt % of fluorine.

Aspect 21. The method defined in any of the preceding aspects, wherein the contacting of the spent catalyst and the fluorine-containing stream occurs, at least partially, at a temperature of about 500° F. to about 1,000° F., about 600° F. to about 1,000° F., about 600° F. to about 900° F., about 700° F. to about 900° F., or about 700° F. to about 850° F.

Aspect 22. The method defined in any of the preceding aspects, wherein the fluorine-containing compound comprises (or consists essentially of, or consists of):
(i) a compound of formula (I) —

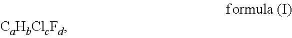

wherein—
a is 1 to 6,
b is 0 to 14,
c is 0 to 14,
d is 1 to 14,
wherein, optionally, b and/or c is not 0, and
wherein b+c+d=2a+2,
wherein, optionally, the compound of formula (I) is substituted;
(ii) 1,1,1,2-tetrafluoroethane;
(iii) difluoromethane; or
(iv) dichlorodifluoromethane.

Aspect 23. The method defined in any of the preceding aspects, wherein the fluorine-containing compound consists of 1,1,1,2-tetrafluoroethane.

Aspect 24. The method defined in any of the preceding aspects, wherein the amount of fluorine-containing compound in the fluorine-containing stream is controlled to give a concentration of fluorine [F] on the catalyst less than any maximum amount or in any range disclosed herein, for example, less than about 10 wt %, less than about 8 wt %, less than about 6 wt %, less than about 4 wt %, less than about 2 wt %, less than 1.5 wt %, in a range from about 0.1 wt % to about 3 wt %, about 1 wt % to about 2 wt %, about 1.25 wt % to about 1.75 wt %, about 0.1 wt % to about 1.0 wt %, about 0.5 wt % to about 1 wt %, or about 0.3 wt % to about 0.8 wt %.

Aspect 25. The method defined in any of the preceding aspects, wherein the fluorine-containing stream is substantially free of oxygen-containing compounds and/or chlorine-containing compounds that do not include a fluorine atom, for example, less than about 100 ppmw, less than about 50 ppmw, or less than about 25 ppmw.

Aspect 26. The method defined in any of the preceding aspects, wherein the amount of fluorine-containing compound in the fluorine-containing stream is controlled to give a concentration of fluorine (F) or fluorine-containing compound less than any maximum amount or in any range disclosed herein, for example, less than about 50,000 ppmv, in a range from about 5 to about 25,000 ppmv, in a range from about 10 to about 25,000 ppmv, in a range from about 50 to about 25,000 ppmv, in a range from about 5,000 to about 25,000 ppmv, in a range from about 50 to about 20,000 ppmv, in a range from about 50 to about 15,000 ppmv, in a range from about 50 to about 10,000 ppmv, in a range from about 50 to about 5,000 ppmv, in a range from about 50 to about 2,500 ppmv, in a range from about 50 to about 1,000 ppmv, in a range from about 500 to about 1,000 ppmv, in a range from about 600 to about 900 ppmv, in a range from about 700 to about 800 ppmv, or about 750 ppmv.

Aspect 27. The method defined in any of the preceding aspects, wherein the fluorination step is conducted at (i) a fluorination temperature in any fluorination temperature range disclosed herein, for example, from about 0° C. to about 600° C., from about 10° C. to about 550° C., from about 20° C. to about 450° C., from about 0° C. to about 300° C., from about 20° C. to about 250° C., or from about 15° C. to about 50° C., (ii) a fluorination pressure of atmospheric pressure to about 15 bar, atmospheric pressure to about 10 bar, atmospheric pressure to about 7 bar, about 0.5 bar to about 10 bar, about 0.5 bar to about 5 bar, about 0.5 bar to about 1.5 bar, about 1 bar, about 2 bar to about 10 bar, about 2 bar to about 5 bar, or about 2 bar.

Aspect 28. The method defined in any of the preceding aspects, wherein the fluorination step is conducted for a time period in any range of fluorination time periods disclosed herein, for example, from about 0.5 hours to about 96 hours, about 0.5 hours to about 72 hours, about 0.5 to about 48 hours, from about 0.5 to about 12 hours, from about 0.5 to about 8 hours, about 0.1 hours to about 96 hours, about 0.1 hours to about 72 hours, about 0.1 to about 48 hours, from about 0.1 to about 12 hours, or from about 0.1 to about 8 hours.

Aspect 29. The method defined in any of the preceding aspects, wherein the chlorine-containing stream comprises (or consists essentially of, or consists of) the chlorine-containing compound and any inert gas disclosed herein, for example, nitrogen.

Aspect 30. The method defined in any of the preceding aspects, further comprising circulating the inert gas, and injecting the chlorine-containing compound into the circulating inert gas.

Aspect 31. The method defined in any of the preceding aspects, wherein the injecting of the chlorine-containing compound is achieved, at least in part, with a spraying apparatus configured to disperse the chlorine-containing compound in the circulating inert gas.

Aspect 32. The method defined in any of the preceding aspects, wherein the chlorine-containing stream comprises (or consists essentially of, or consists of) chlorine gas (Cl₂) and nitrogen.

Aspect 33. The method defined in any of the preceding aspects, wherein the amount of chlorine-containing compound in the chlorine-containing stream is controlled to give a concentration of chlorine (Cl) or chlorine-containing compound less than any maximum amount or in any range disclosed herein, for example, less than about 50,000 ppmv, in a range from about 5 to about 25,000 ppmv, in a range from about 10 to about 25,000 ppmv, in a range from about 50 to about 25,000 ppmv, in a range from about 50 to about 20,000 ppmv, in a range from about 50 to about 15,000 ppmv, in a range from about 50 to about 10,000 ppmv, in a range from about 50 to about 5,000 ppmv, in a range from about 50 to about 2,500 ppmv, in a range from about 50 to about 1,000 ppmv, in a range from about 50 to about 500 ppmv, in a range from about 50 to about 100 ppmv, in a range from about 100 to about 750 ppmv, or in a range from about 500 to about 600 ppmv.

Aspect 34. The method defined in any of the preceding aspects, wherein (i) the amount of chlorine or chlorine-containing compound in the chlorine-containing stream, (ii) the duration of the contacting of the treated spent catalyst and the chlorine-containing stream, or (iii) a combination thereof is controlled to place on the treated spent catalyst about 0.1 wt % to about 2 wt %, about 0.5 wt % to about 1.5 wt %, about 0.5 wt % to about 1 wt %, or 0.6 wt % to about 1 wt % of chlorine or the chlorine-containing compound.

Aspect 35. The method defined in any of the preceding aspects, wherein the chlorine-containing stream is substantially free of oxygen-containing compounds and/or fluorine-containing compounds, for example, less than about 100 ppmw.

Aspect 36. The method defined in any of the preceding aspects, wherein the chlorination step is conducted at a chlorination temperature in any chlorination temperature range disclosed herein, for example, from about 0° F. to about 600° F., from about 100° F. to about 600° F., from about 200° F. to about 600° F., from about 3000° F. to about 600° F., from about 400° F. to about 600° F., from about 400° F. to about 500° F., from about 400° F. to about 450° F., from about 300° F. to about 500° F., from about 350° F. to about 500° F., or from about 350° F. to about 450° F.

Aspect 37. The method defined in any of the preceding aspects, wherein the chlorination step is conducted for a time period in any range of chlorination time periods disclosed herein, for example, from about 0.5 hours to about 72 hours, from about 0.75 hours to about 60 hours, from about 1 to about 48 hours, from about 1 to about 12 hours, from about 2 to about 8 hours, from about 0.10 hours to about 72 hours, from about 0.50 hours to about 60 hours, from about 0.5 to about 48 hours, from about 0.5 to about 12 hours, or from about 1 to about 8 hours.

Aspect 38. The method defined in any of the preceding aspects, wherein the decoking gas stream comprises (or consists essentially of, or consists of) any combination of an inert gas (one or more) and oxygen disclosed herein, for example, a mixture of nitrogen and oxygen, air, or a mixture of air and nitrogen.

Aspect 39. The method defined in any of the preceding aspects, wherein the decoking gas stream comprises a mole % of oxygen less than any maximum amount or in any range disclosed herein, for example, less than about 5 mole %, in a range from about 0.1 to about 10 mole %, in a range of about 0.1 to about 8 mole %, in a range from about 0.1 to about 5 mole %, in a range from about 0.5 to about 3 mole %, or in a range from about 0.5 to about 6 mole %.

Aspect 40. The method defined in any of the preceding aspects, wherein the decoking gas stream is substantially free of halogen-containing compounds, such as added halogen-containing compounds (e.g., substantially halogen-free, substantially chlorine-free), for example, less than about 100 ppmw.

Aspect 41. The method defined in any of the preceding aspects, wherein the decoking gas stream is substantially free of water (e.g., added water), for example, less than about 100 ppmw.

Aspect 42. The method defined in any of the preceding aspects, wherein the temperature of the carbon burning of the stripped spent catalyst is about 300° F. to about 600° F., about 350° F. to about 550° F., about 350° F. to about 500° F., about 400° F. to about 475° F.

Aspect 43. The method defined in any of the preceding aspects, wherein the carbon burning of the stripped spent catalyst occurs for a time of about 1 minute to about 24 hours, about 1 minute to about 18 hours, about 1 minute to about 12 hours, about 1 minute to about 6 hours, or about 1 minute to about 2 hours.

Aspect 44. The method defined in any of the preceding aspects, wherein the carbon burning of the stripped spent catalyst removes from the spent catalyst at least 90 wt %, at least 95 wt %, at least 99 wt %, or 100 wt % of the hydrocarbon feed.

Aspect 45. The method defined in any of the preceding aspects, wherein the carbon burning of the stripped spent catalyst removes from the spent catalyst at least 90 wt %, at least 95 wt %, at least 99 wt %, or 100 wt % of the aromatic product.

Aspect 46. The method defined in any of the preceding aspects, wherein an amount of soft coke is absorbed and/or adsorbed to the spent catalyst, and the carbon burning of the stripped spent catalyst reduces the amount of soft coke absorbed and/or adsorbed to the spent catalyst.

Aspect 47. The method defined in any of the preceding aspects, wherein the temperature of the carbon burning of the chlorinated spent catalyst is about 500° F. to about 1,200° F., about 500° F. to about 1,100° F., about 500° F. to about 1,000° F., about 600° F. to about 1,000° F., about 700° F. to about 1,000° F., about 700° F. to about 900° F., about 800° F. to about 900° F., or about 850° F.

Aspect 48. The method defined in any of the preceding aspects, wherein the carbon burning of the chlorinated spent catalyst occurs for a time of about 1 minute to about 24 hours, about 1 minute to about 18 hours, about 1 minute to about 12 hours, about 1 minute to about 6 hours, or about 1 minute to about 2 hours.

Aspect 49. The method defined in any of the preceding aspects, wherein the carbon burning of the chlorinated catalyst improves the dispersion of the transition metal in the chlorinated spent catalyst by at least 40%, at least 50%, at least 60%, at least 70%, at least 80%, or at least 90%.

Aspect 50. The method defined in any of the preceding aspects, wherein the temperature of the carbon burning of the chlorinated spent catalyst is about 500° F. to about 1,200° F., about 500° F. to about 1,100° F., about 500° F. to about 1,000° F., about 600° F. to about 1,000° F., about 700° F. to about 1,000° F., about 700° F. to about 900° F., about 800° F. to about 900° F., or about 850° F.

Aspect 51. The method defined in any of the preceding aspects, wherein the carbon burning of the chlorinated spent catalyst occurs for a time of about 1 minute to about 24 hours, about 1 minute to about 18 hours, about 1 minute to about 12 hours, about 1 minute to about 6 hours, or about 1 minute to about 2 hours.

Aspect 52. The method defined in any of the preceding aspects, wherein the carbon burning of the chlorinated catalyst improves the dispersion of the transition metal in the chlorinated spent catalyst by at least 40%, at least 50%, at least 60%, at least 70%, at least 80%, or at least 90%.

Aspect 53. The method defined in any of the preceding aspects, wherein a carbon burn step is conducted at a peak decoking temperature in any peak decoking temperature range disclosed herein, for example, from about 100° C. to about 700° C., from about 125° C. to about 650° C., from about 150° C. to about 600° C., from about 200° C. to about 500° C., or from about 350° C. to about 450° C.

Aspect 54. The method defined in any of the preceding aspects, wherein a carbon burn step is started at an initial decoking temperature which is the same as any chlorine purging temperature disclosed herein, for example, from about 0° C. to about 300° C., from about 20° C. to about 275° C., from about 20° C. to about 250° C., or from about 50° C. to about 200° C.

Aspect 55. The method defined in any of the preceding aspects, wherein the carbon burn step is conducted for a time period in any range of de-coking time periods disclosed herein, for example, from about 0.5 hours to about 120 hours, from about 0.75 hours to about 108 hours, from about 1 hour to about 96 hours, from about 1 to about 72 hours, from about 12 to about 48 hours, or from about 1 to about 6 hours.

Aspect 56. The method defined in any of the preceding aspects, wherein the carbon burn step is conducted for a time period sufficient to reduce the wt % of carbon on the chlorinated spent catalyst to less than any maximum weight percentage of carbon disclosed herein, for example, less than about 1 wt %, less than about 0.5 wt %, or less than about 0.2 wt %.

Aspect 57. The method defined in any of the preceding aspects, wherein the method further comprises a partial decoking step prior to the chlorination step, the partial decoking step comprising contacting the spent catalyst with a partial decoking gas stream comprising oxygen.

Aspect 58. The method defined in any of the preceding aspects, wherein the partial decoking gas stream comprises (or consists essentially of, or consists of) any combination of an inert gas (one or more) and oxygen disclosed herein, for example, a mixture of nitrogen and oxygen, or air.

Aspect 59. The method defined in any of the preceding aspects, wherein the partial decoking gas stream comprises a mole % of oxygen less than any maximum amount or in any range disclosed herein, for example, less than about 5 mole %, or in a range from about 0.5 to about 3 mole %, from about 1 to about 3 mole %, from about 0.1 to about 4 mole %, or from about 0.1 to about 3 mole %.

Aspect 60. The method defined in any of the preceding aspects, wherein the partial decoking gas stream is substantially free of halogen-containing compounds (e.g., substantially halogen-free), for example, less than about 100 ppmw.

Aspect 61. The method defined in any of the preceding aspects, wherein the decoking gas stream is substantially free of water, for example, less than about 100 ppmw.

Aspect 62. The method defined in any of the preceding aspects, wherein the partial decoking step is conducted at a partial decoking temperature in any partial decoking temperature range disclosed herein, for example, from about 150° C. to about 600° C., from about 150° C. to about 250° C.

Aspect 63. The method defined in any of the preceding aspects, wherein the partial decoking step is conducted for a time period in any range of partial de-coking time periods disclosed herein, for example, from about 1 hour to about 48 hours, or from about 2 to about 24 hours.

Aspect 64. The method defined in any of the preceding aspects, wherein the partial decoking step is conducted for a time period sufficient to reduce the wt % of carbon on the spent catalyst to any range of weight percentage of carbon disclosed herein, for example, from about 0.05 wt % to about 10 wt %, from about 0.1 wt % to about 10 wt %, from about 0.05 wt % to about 5 wt %, from about 0.1 wt % to about 5 wt %, from about 1 wt % to 10 wt %, or from about 4 wt % to about 5 wt %.

Aspect 65. The method defined in any of the preceding aspects, wherein the method further comprises a pre-drying step prior to the chlorination step, the pre-drying step comprising contacting the spent catalyst with a pre-drying gas stream comprising (or consisting essentially of, or consisting of) any inert gas disclosed herein, for example, nitrogen.

Aspect 66. The method defined in any of the preceding aspects, wherein the pre-drying gas stream is substantially free of oxygen-containing compounds, for example, less than about 100 ppmw.

Aspect 67. The method defined in any of the preceding aspects, wherein the pre-drying step is conducted at a pre-drying temperature in any pre-drying temperature range disclosed herein, for example, from about 75° C. to about 500° C., from about 100° C. to about 500° C., from about 0° C. to about 400° C., from about 100° C. to about 400° C., from about 125° C. to about 300° C., or from about 180° C. to about 280° C.

Aspect 68. The method defined in any of the preceding aspects, wherein the pre-drying step is conducted for a time period in any range of pre-drying time periods disclosed herein, for example, from about 1 hour to about 96 hours, or from about 1 to about 48 hours.

Aspect 69. The method defined in any of the preceding aspects, wherein the pre-drying step is conducted for a time period sufficient to reduce the moisture content of the spent catalyst to less than any maximum moisture content of the spent catalyst disclosed herein, for example, less than about 4 wt %, or less than about 1 wt %.

Aspect 70. The method defined in any of the preceding aspects, wherein the method further comprises a chlorine purging step prior to the carbon burn step, the chlorine purging step comprising contacting the chlorinated spent catalyst with a chlorine purging stream comprising (or consisting essentially of, or consisting of) any inert gas disclosed herein, for example, nitrogen.

Aspect 71. The method defined in any of the preceding aspects, wherein the chlorine purging stream is substantially free of oxygen-containing compounds, for example, less than about 100 ppmw.

Aspect 72. The method defined in any of the preceding aspects, wherein the chlorine purging stream is substantially free of halogen-containing compounds (substantially halogen-free), for example, less than about 100 ppmw.

Aspect 73. The method defined in any of the preceding aspects, wherein the chlorine purging step is conducted at a chlorine purging temperature in any chlorine purging temperature range disclosed herein, for example, from about 0° C. to about 400° C., from about 15° C. to about 350° C., from about 15° C. to about 300° C., or from about 25° C. to about 250° C.

Aspect 74. The method defined in any of the preceding aspects, wherein the chlorine purging step is conducted for a time period in any range of chlorine purging time periods disclosed herein, for example, from about 1 hour to about 96 hours, from about 1 to about 48 hours.

Aspect 75. The method defined in any of the preceding aspects, wherein the chlorine purging step is conducted for a time period sufficient to reduce the chlorine content of the outgoing chlorine purging effluent stream, after contacting the chlorinated spent catalyst, to less than any maximum chlorine content described herein, for example, less than about 100 ppmw of chlorine-containing compounds.

Aspect 76. The method defined in any of the preceding aspects, wherein the method further comprises a fluorine purging step after the fluorination step, the fluorine purging step comprising contacting the de-coked and fluorinated catalyst with a fluorine purging stream comprising (or consisting essentially of, or consisting of) any inert gas disclosed herein, for example, nitrogen.

Aspect 77. The method defined in any of the preceding aspects, wherein the fluorine purging stream is substantially free of oxygen-containing compounds, for example, less than about 100 ppmw.

Aspect 78. The method defined in any of the preceding aspects, wherein the fluorine purging stream is substantially free of halogen-containing compounds (substantially halogen-free), for example, less than about 100 ppmw.

Aspect 79. The method defined in any of the preceding aspects, wherein the fluorine purging step is conducted at a fluorine purging temperature in any fluorine purging temperature range disclosed herein, for example, from about 0° C. to about 500° C., from about 0° C. to about 400° C., from about 15° C. to about 475° C., from about 15° C. to about 300° C., or from about 25° C. to about 250° C., or from about 25° C. to about 450° C., such as about 450° C.

Aspect 80. The method defined in any of the preceding aspects, wherein the fluorine purging step is conducted for a time period in any range of fluorine purging time periods disclosed herein, for example, from about 0.25 hours to about 72 hours, or from about 1 to about 48 hours.

Aspect 81. The method defined in any of the preceding aspects, wherein the fluorine purging step is conducted for a time period sufficient to reduce the fluorine content of the outgoing fluorine purging effluent stream, after contacting the de-coked and fluorinated catalyst, to less than any maximum fluorine content described herein, for example, less than about 100 ppmw of fluorine-containing compounds.

Aspect 82. The method defined in any of the preceding aspects, wherein the method further comprises an oxygen purging step after the carbon burn step or fluorine purge step, the oxygen purging step comprising contacting the catalyst with an oxygen purging stream comprising (or consisting essentially of, or consisting of) any inert gas disclosed herein, for example, nitrogen.

Aspect 83. The method defined in any of the preceding aspects, wherein the oxygen purging stream is substantially free of oxygen-containing compounds, for example, less than about 100 ppmw.

Aspect 84. The method defined in any of the preceding aspects, wherein the oxygen purging stream is substantially free of halogen-containing compounds (substantially halogen-free), for example, less than about 100 ppmw.

Aspect 85. The method defined in any of the preceding aspects, wherein the oxygen purging step is conducted at an oxygen purging temperature in any oxygen purging temperature range disclosed herein, for example, from about 0° C. to about 400° C., from about 15° C. to about 350° C., from about 25° C. to about 325° C., from about 25° C. to about 300° C., from about 15° C. to about 300° C., from about 25° C. to about 260° C., from about 25° C. to about 250° C., from about 0° C. to about 600° C., from about 15° C. to about 550° C., from about 25° C. to about 500° C., or from about 25° C. to about 450° C.

Aspect 86. The method defined in any of the preceding aspects, wherein the oxygen purging step is conducted for a time period in any range of oxygen purging time periods disclosed herein, for example, from about 0.5 hours to about 96 hours, or from about 1 to about 48 hours.

Aspect 87. The method defined in any of the preceding aspects, wherein the oxygen purging step is conducted for a time period sufficient to reduce the oxygen content of the outgoing oxygen purging effluent stream, after contacting the catalyst, to less than any maximum oxygen content described herein, for example, less than about 100 ppmw of oxygen-containing compounds.

Aspect 88. The method defined in any of the preceding aspects, wherein the method further comprises a hydrocarbon treatment step prior to the carbon burn step, the hydrocarbon treatment step comprising contacting the chlorinated spent catalyst with a hydrocarbon treatment stream comprising a hydrocarbon feed.

Aspect 89. The method defined in any of the preceding aspects, wherein the hydrocarbon feed comprises (or consists essentially of, or consists of) C₆-C₈ alkanes and/or cycloalkanes.

Aspect 90. The method defined in any of the preceding aspects, wherein the hydrocarbon treatment step is conducted at a hydrocarbon treatment temperature in any hydrocarbon treatment temperature range disclosed herein, for example, from about 400° C. to about 600° C.

Aspect 91. The method defined in any of the preceding aspects, wherein the hydrocarbon treatment step is conducted for a time period in any range of hydrocarbon treatment time periods disclosed herein, for example, from about 1 to about 48 hours.

Aspect 92. The method defined in any of the preceding aspects, wherein the method further comprises a reducing step after the fluorination step.

Aspect 93. The method defined in any of the preceding aspects, wherein the reducing step comprises contacting the regenerated catalyst, the fluorinated spent catalyst, or the de-coked and fluorinated catalyst with a reducing gas stream comprising (or consisting essentially of, or consisting of) molecular hydrogen.

Aspect 94. The method defined in any of the preceding aspects, wherein the reducing of the fluorinated spent catalyst or the regenerated catalyst occurs at a temperature of about 600° F. to about 1,200° F., about 700° F. to about 1,100° F., about 800° F. to about 1,000° F., about 900° F. to about 1,000° F., or about 950° F. to about 1,000° F.

Aspect 95. The method defined in any of the preceding aspects, wherein the reducing of the fluorinated spent catalyst or the regenerated catalyst occurs, at least partially, in an atmosphere comprising (consisting essentially of, or consisting of) an inert gas (such as nitrogen), hydrogen (H₂), or a combination thereof, wherein optionally the volume ratio of the inert gas to the hydrogen (H₂) is about 10:90 to about 90:10, about 20:80 to about 80:20, or about 40:60 to about 60:40.

Aspect 96. The method defined in any of the preceding aspects, wherein the reducing gas stream comprises a mole % of molecular hydrogen greater than any minimum amount or in any range disclosed herein, for example, greater than about 25 mole %, or greater than about 75 mole %.

Aspect 97. The method defined in any of the preceding aspects, wherein the reducing step is conducted at a peak reducing temperature in any peak reducing temperature range disclosed herein, for example, from about 200° C. to about 600° C., or from about 400° C. to about 600° C.

Aspect 98. The method defined in any of the preceding aspects, wherein the reducing step is started at an initial reducing temperature which is the same as any oxygen purge temperature disclosed herein, for example, in a range from about 0° C. to about 600° C., from about 15° C. to about 550° C., from about 25° C. to about 500° C., from about 25° C. to about 450° C., from about 0° C. to about 500° C., from about 0° C. to about 300° C., from about 20° C. to about 250° C., or from about 15° C. to about 50° C.

Aspect 99. The method defined in any of the preceding aspects, wherein the reducing step is conducted for a time period in any range of reducing step time periods disclosed herein, for example, from about 0.5 hours to about 48 hours, from about 10 to about 30 hours.

Aspect 100. The method defined in any of the preceding aspects, wherein the catalyst support comprises (or consists essentially of, or consists of) a zeolite, an amorphous inorganic oxide, or any combination thereof.

Aspect 101. The method defined in any of the preceding aspects, wherein the catalyst support comprises (or consists essentially of, or consists of) an L-zeolite, a Y-zeolite, a mordenite, an omega zeolite, and/or a beta zeolite.

Aspect 102. The method defined in any of the preceding aspects, wherein the catalyst support comprises (or consists essentially of, or consists of) a potassium L-zeolite or a barium ion-exchanged L-zeolite.

Aspect 103. The method defined in any of the preceding aspects, wherein the catalyst support comprises (or consists essentially of, or consists of) a binder comprising alumina, silica, a mixed oxide thereof, or a mixture thereof.

Aspect 104. The method defined in any of the preceding aspects, wherein the transition metal comprises a Group 8-11 transition metal.

Aspect 105. The method defined in any of the preceding aspects, wherein the transition metal comprises (or consists essentially of, or consists of) platinum.

Aspect 106. The method defined in any of the preceding aspects, wherein the catalyst comprises any weight percentage range of transition metal disclosed herein, for example, from about 0.1 wt % to about 10 wt %, or from about 0.3 wt % to about 5 wt %, transition metal.

Aspect 107. The method defined in any of the preceding aspects, wherein the spent catalyst comprises any weight percentage range of platinum disclosed herein, for example, from about 0.1 wt % to about 10 wt %, or from about 0.5 wt % to about 2 wt %, platinum.

Aspect 108. The method defined in any of the preceding aspects, wherein the catalyst comprises (or consists essentially of, or consists of) platinum on a KL-zeolite.

Aspect 109. The method defined in any of the preceding aspects, wherein the catalyst further comprises chlorine and fluorine.

Aspect 110. The method defined in any of the preceding aspects, wherein the catalyst comprises any weight percentage range of chlorine and/or weight percentage range of fluorine disclosed herein, for example, from about 0.01 wt % to about 5 wt %, or from about 0.3 to about 1.3 wt % fluorine, and/or from about 0.01 wt % to about 5 wt %, from about 0.3 wt % to about 3 wt %, or from about 0.3 to about 1.3 wt % chlorine.

Aspect 111. The method defined in any of the preceding aspects, wherein the catalyst comprises any molar ratio of chlorine:fluorine disclosed herein, for example, from about 0.5:1 to about 4:1.

Aspect 112. The method defined in any of the preceding aspects, wherein the chlorine-containing compound comprises (or consists essentially of, or consists of) hydrochloric acid, chlorine gas (Cl₂), carbon tetrachloride, tetrachloroethylene, chlorobenzene, methyl chloride, methylene chloride, chloroform, allyl chloride, trichloroethylene, a chloramine, a chlorine oxide, a chlorine acid, chlorine dioxide, dichlorine monoxide, dichlorine heptoxide, chloric acid, perchloric acid, ammonium chloride, tetramethylammonium chloride, tetraethylammonium chloride, tetrapropylammonium chloride, tetrabutylammonium chloride, methyltriethylammonium chloride, or any combination thereof.

Aspect 113. The method defined in any of the preceding aspects, wherein the chlorine-containing compound comprises (or consists essentially of, or consists of) chlorine gas (Cl₂).

Aspect 114. A reactivated catalyst or a regenerated catalyst produced by the method defined in any one of the preceding aspects.

Aspect 115. The reactivated catalyst or regenerated catalyst defined in any of the preceding aspects, wherein the reactivated catalyst or regenerated catalyst comprises any amount of iron disclosed herein, for example, less than about 400 ppmw, less than about 300 ppmw, less than about 250 ppmw, from about 5 ppmw to about 400 ppmw, from about 50 ppmw to about 300 ppmw, or from about 50 ppmw to about 250 ppmw iron.

Aspect 116. The reactivated catalyst or regenerated catalyst defined in any of the preceding aspects, wherein the reactivated catalyst or regenerated catalyst comprises any amount of carbon disclosed herein, for example, less than about 1 wt %, less than about 0.5 wt %, from about 0.01 wt % to about 1 wt %, from about 0.01 wt % to about 0.75 wt %, from about 0.01 wt % to about 0.5 wt %, or from about 0.02 wt % to about 0.5 wt % carbon.

Aspect 117. The reactivated catalyst or regenerated catalyst defined in any one of the preceding aspects, wherein the reactivated catalyst or regenerated catalyst comprises any amount of chlorine disclosed herein, for example, from about 0.01 wt % to about 5 wt %, from about 0.05 wt % to about 3 wt %, from about 0.05 wt % to about 2.0 wt %, or from about 0.3 wt % to about 1.3 wt % chlorine.

Aspect 118. The reactivated catalyst or regenerated catalyst defined in any one of the preceding aspects, wherein the reactivated catalyst or regenerated catalyst comprises any amount of fluorine disclosed herein, for example, about 0.01 wt % to about 5 wt %, from about 0.05 wt % to about 3 wt %, from about 0.01 wt % to about 3 wt %, from about 0.1 wt % to about 1.3 wt %, or from about 0.15 wt % to about 1.3 wt % fluorine.

Aspect 119. The reactivated catalyst or regenerated catalyst defined in any one of the preceding aspects, wherein the reactivated catalyst or regenerated catalyst is characterized by a TEOR within about 50° F., within about 40° F., within about 30° F., or within about 20° F., of the TEOR of a fresh reference catalyst.

Aspect 120. The reactivated catalyst or regenerated catalyst defined in any one of the preceding aspects, wherein the reactivated catalyst or regenerated catalyst is characterized by a TSOR within about 50° F., within about 40° F., within about 30° F., or within about 20° F., of the TSOR of a fresh reference catalyst.

Aspect 121. The reactivated catalyst or regenerated catalyst defined in any one of the preceding aspects, wherein the reactivated catalyst or regenerated catalyst is characterized by a fouling rate (FR) in any range disclosed herein, for example, from about 0.01° F./hr to about 0.25° F./hr, from about 0.02° F./hr to about 0.2° F./hr, from about 0.03° F./hr to about 0.2° F./hr, or from about 0.03° F./hr to about 0.15° F./hr.

Aspect 122. The reactivated catalyst or regenerated catalyst defined in any one of the preceding aspects, wherein the reactivated catalyst or regenerated catalyst is characterized by a benzene+toluene selectivity in any selectivity range disclosed herein, for example, from about 0.88 to about 0.95, or from about 0.89 to about 0.94; or greater than 0.88, or greater than 0.90.

Aspect 123. The method or catalyst defined in any of the preceding aspects, wherein the metal reactor (or metal reactor system) comprises (or consists essentially of, or consists of) stainless steel, e.g., 347SS or 321SS.

Aspect 124. The method or catalyst defined in any of the preceding aspects, further comprising, consisting essentially of, or consisting of recovering at least a portion of the fluorine-containing stream to produce a recovered fluorine-containing stream, wherein, optionally, the recovering occurs after the contacting of the de-coked catalyst with the fluorine-containing stream; and contacting the de-coked catalyst with the recovered fluorine-containing stream.

Aspect 125. The method or catalyst defined in any of the preceding aspects, wherein a concentration of fluorine in the regenerated catalyst is about 0.15 wt % to about 1.2 wt %, or about 0.2 wt % to about 1.2 wt %.

Aspect 126. The method or catalyst defined in any of the preceding aspects, wherein a concentration gradient of fluorine in a regenerated catalyst is 60% or less, 50% or less, 40% or less, 30% or less, 20% or less, or 10% or less.

Aspect 127. A method of producing a product, the method comprising, consisting essentially of, or consisting of: (A) providing a reactivated or regenerated catalyst, such as any of those of the preceding aspects, and (B) contacting a hydrocarbon and the reactivated/regenerated catalyst to produce a product, such as an aromatic product.

Aspect 128. The method defined in any of the preceding aspects, wherein the contacting of the hydrocarbon and the reactivated/regenerated catalyst occurs for a time effective to produce a second spent catalyst, and the method further comprises subjecting the second spent catalyst to the method defined in any of the preceding aspects.

Aspect 129. (I) A method of contacting a spent catalyst with a fluorine-containing stream, or (II) The method defined in any of the preceding aspects, wherein the contacting of the spent catalyst, such as the redistributed spent catalyst, with a fluorine-containing stream comprises, consists essentially of, or consists of—
(a) providing two or more reactors in fluid communication with each other, wherein the two or more reactors (e.g., 2 to 10 reactors, or more) are connected in a series, thereby permitting a fluorine-containing stream to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors, wherein each of the two or more reactors includes a reservoir in which the spent catalyst is disposed;
(b) heating one of the two or more reactors to a temperature that is equal to or greater than a fluorination temperature, and maintaining each of the remaining reactors of the two or more reactors at a temperature less than the fluorination temperature, wherein the fluorination temperature is effective to at least partially decompose a fluorine-containing compound of the fluorine-containing stream; and
(c) injecting the fluorine-containing stream and circulating or recirculating the fluorine-containing stream for a time effective to achieve a desired level of fluorination of the spent catalyst in the one of the two or more reactors at the temperature that is equal to or greater than the fluorination temperature.

Aspect 130. The method defined in any of the preceding aspects, further comprising, consisting essentially of, or consisting of:
(d) heating a different one of the two or more reactors to a temperature that is equal to or greater than the fluorination temperature, and maintaining each of the remaining reactors of the two or more reactors at a temperature less than the fluorination temperature; and
(e) injecting the fluorine-containing stream and circulating or recirculating the fluorine-containing stream for a time effective to achieve a desired level of fluorination of the spent catalyst in the different one of the two or more reactors at the temperature that is equal to or greater than the fluorination temperature.

Aspect 131. The method defined in any of the preceding aspects, further comprising repeating steps (d) and (e) until the spent catalyst in each of the one or more reactors is fluorinated to a desired level.

Aspect 132. The method defined in any of the preceding aspects, wherein the temperature that is equal to or greater than the fluorination temperature is at least 650° F., or at least 700° F.

Aspect 133. The method defined in any of the preceding aspects, wherein the temperature that is equal to or greater than the fluorination temperature is about 650° F. to about 850° F., about 700° F. to about 850° F., about 700° F. to about 800° F., about 700° F. to about 775° F., or about 700° F. to about 750° F.

Aspect 134. The method defined in any of the preceding aspects, wherein the temperature that is less than the fluorination temperature is about 600° F. or less.

Aspect 135. The method defined in any of the preceding aspects, wherein the temperature that is less than the fluorination temperature is about 300° F. to about 600° F., about 400° F. to about 600° F., or about 500° F. to about 600° F.

Aspect 136. The method defined in any of the preceding aspects, wherein the injecting of the fluorine-containing stream comprises, consists essentially of, or consists of:
(1) selecting the injection point from the one or more injection points, wherein, optionally, the injection point selected is upstream of the one reactor (or the different reactor) heated to the temperature that is equal to or greater than the fluorination temperature, and
(2) injecting the fluorine-containing stream in the injection joint selected from the one or more injection points.

Aspect 137. The method defined in any of the preceding aspects, wherein an amount of the fluorine-containing compound or the fluorine-containing stream that is injected and circulated/recirculated is effective to place on the spent catalyst about 0.1 wt % to about 1.5 wt %, about 0.5 wt % to about 1.5 wt % of fluorine, or about 0.15 wt % to about 1.2 wt % of fluorine.

Aspect 138. The method defined in any of the preceding aspects, further comprising, consisting essentially of, or consisting of analyzing the fluorine-containing stream during the circulating or recirculating of the fluorine-containing stream to determine an amount or concentration of the fluorine-containing compound and/or fluorine in the fluorine-containing stream.

Aspect 139. The method defined in any of the preceding aspects, further comprising, consisting essentially of, or consisting of stopping the circulating/recirculating of the fluorine-containing stream when the amount or concentration of the fluorine-containing compound and/or fluorine is at or below a threshold concentration or amount that indicates successful deposition of fluorine on the spent catalyst.

Aspect 140. A system for fluorinating a spent catalyst, the system comprising, consisting essentially of, or consisting of:
(a) two or more reactors in fluid communication with each other, wherein the two or more reactors are connected in a series, thereby permitting a fluid stream, such as a fluorine-containing stream, to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors; and
(b) two or more heating apparatuses configured to heat each of the two or more reactors to the same or different temperatures.

Aspect 141. The system of Aspect 140, wherein the system comprises at least one injection point for every reactor.

Aspect 142. The system of Aspect 141, wherein the at least one injection point is positioned to allow a fluorine-containing stream to be injected immediately upstream of any one of the two or more reactors.

What is claimed is:

1. A method of regenerating a spent catalyst comprising a transition metal and a catalyst support in a metal reactor, the method comprising:
(1) contacting the spent catalyst with hydrogen gas to produce a stripped spent catalyst;
(2) subjecting the stripped spent catalyst to a carbon burn at a temperature not exceeding about 500° F. to produce a treated spent catalyst;
(3) contacting the treated spent catalyst with a chlorine-containing stream comprising a chlorine-containing compound to produce a chlorinated spent catalyst;
(4) subjecting the chlorinated spent catalyst to a carbon burn at a temperature not exceeding 900° F., for a time effective to improve a dispersion of the transition metal in the chlorinated spent catalyst to form a redistributed spent catalyst; and
(5) contacting the redistributed spent catalyst with a fluorine-containing stream comprising a fluorine-containing compound to form a regenerated catalyst; and
(6) reducing the regenerated catalyst.

2. The method of claim 1, wherein the fluorine-containing compound comprises a compound of formula (I): 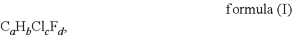
wherein—
a is 1 to 6,
b is 0 to 14,
c is 0 to 14, and
d is 1 to 14,
wherein, optionally, (i) b is not 0, (ii) c is not 0, or (iii) a combination thereof, and
wherein b+c+d=2a+2.

3. The method of claim 1, wherein the fluorine-containing compound consists of 1,1,1,2-tetrafluoroethane.

4. The method of claim 1, wherein the fluorine-containing compound consists of difluoromethane.

5. The method of claim 1, wherein the fluorine-containing compound consists of dichlorodifluoromethane.

6-7. (canceled)

8. The method of claim 1, wherein (i) an amount of the fluorine-containing compound in the fluorine-containing stream, (ii) a duration of the contacting of the redistributed spent catalyst with the fluorine-containing stream, or (iii) a combination thereof is selected to place on the redistributed spent catalyst about 0.15 wt % to about 1.2 wt % of fluorine.

9-20. (canceled)

21. A method of contacting a spent catalyst with a fluorine-containing stream, the method comprising:
(a) providing two or more reactors in fluid communication with each other, wherein the two or more reactors are connected in a series, thereby permitting a fluorine-containing stream to be (i) injected at an injection point selected from one or more injection points, (ii) circulated sequentially through each of the two or more reactors downstream of the injection point, (iii) returned to a first of the two or more reactors, and optionally (iv) recirculated sequentially through each of the two or more reactors, wherein each of the two or more reactors includes a reservoir in which the spent catalyst is disposed;
(b) heating one of the two or more reactors to a temperature that is equal to or greater than a fluorination temperature, and maintaining each of the remaining reactors of the two or more reactors at a temperature less than the fluorination temperature, wherein the fluorination temperature is effective to at least partially decompose a fluorine-containing compound of the fluorine-containing stream; and
(c) injecting the fluorine-containing stream and circulating or recirculating the fluorine-containing stream for a time effective to achieve a desired level of fluorination of the spent catalyst in the one of the two or more reactors at the temperature that is equal to or greater than the fluorination temperature.

22. The method of claim 21, further comprising:
(d) heating a different one of the two or more reactors to a temperature that is equal to or greater than the fluorination temperature, and maintaining each of the remaining reactors of the two or more reactors at a temperature less than the fluorination temperature; and
(e) injecting the fluorine-containing stream and circulating or recirculating the fluorine-containing stream for a time effective to achieve a desired level of fluorination of the spent catalyst in the different one of the two or more reactors at the temperature that is equal to or greater than the fluorination temperature.

23. (canceled)

24. The method of claim 21, wherein the temperature that is equal to or greater than the fluorination temperature is at least 650° F., and wherein the temperature that is less than the fluorination temperature is about 600° F. or less.

25-29. (canceled)

30. The method of claim 21, wherein an amount of the fluorine-containing compound or the fluorine-containing stream that is injected and circulated/recirculated is effective to place on the spent catalyst about 0.1 wt % to about 1.5 wt % of fluorine.

31-40. (canceled)

41. A method of regenerating a spent catalyst comprising a transition metal and a catalyst support in a metal reactor, the method comprising:
(1) contacting the spent catalyst with a chlorine-containing stream comprising a chlorine-containing compound to produce a chlorinated spent catalyst;
(2) contacting the chlorinated spent catalyst with a decoking gas stream comprising oxygen to produce a de-coked catalyst; and
(3) contacting the de-coked catalyst with a fluorine-containing stream comprising a fluorine-containing compound to produce a regenerated catalyst, wherein the fluorine-containing compound comprises a hydrofluorocarbon (HFC), a chlorofluorocarbon (CFC), a hydrochlorofluorocarbon (HCFC), or a combination thereof.

42. The method of claim 41, wherein the fluorine-containing compound comprises a compound of formula (I): 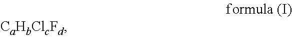
wherein—
a is 1 to 6,
b is 0 to 14,
c is 0 to 14, and
d is 1 to 14,
wherein, optionally, (i) b is not 0, (ii) c is not 0, or (iii) a combination thereof, and
wherein b+c+d=2a+2.

43-44. (canceled)

45. The method of claim 41, wherein the fluorine-containing compound comprises 1,1,1,2-tetrafluoroethane.

46. The method of claim 41, wherein the fluorine-containing compound comprises dichlorodifluoromethane, difluoromethane, or a combination thereof.

47. (canceled)

48. The method of claim 41, wherein the fluorine-containing stream further comprises an inert gas and air at a volume ratio of about 3:1 to about 5:1 (inert gas:air).

49. The method of claim 41, wherein the fluorine-containing compound is present in the fluorine-containing stream at an amount effective to impart a concentration of fluorine [F] in the fluorine-containing stream of from about 0.05 wt % to about 3 wt %.

50. The method of claim 41, wherein the fluorine-containing stream is substantially free of oxygen-containing compounds, chlorine-containing compounds that do not include a fluorine atom, or oxygen-containing compounds and chlorine-containing compounds that do not include a fluorine atom.

51-53. (canceled)

54. The method of claim 41, further comprising:
recovering at least a portion of the fluorine-containing stream to produce a recovered fluorine-containing stream, wherein the recovering occurs after the contacting of the de-coked catalyst with the fluorine-containing stream; and
contacting the de-coked catalyst with the recovered fluorine-containing stream.

55. The method of claim 41, wherein a concentration of fluorine in the regenerated catalyst is about 0.03 wt % to about 1.3 wt %.

56. The method of claim 41, wherein a concentration gradient of fluorine in the regenerated catalyst is 60% or less.

57-60. (canceled)
